(19) United States
(12) Patent Application Publication
(10) Pub. No.: US 2011/0038028 A1
(43) Pub. Date: Feb. 17, 2011

(54) Optical Imaging Lens systems and components

(76) Inventor: Saman Dharmatilleke, Singapore (SG)

Correspondence Address: Namal Warshakoon, 2909 Oakton Crest place, Vienna, VA, 22181, US

(21) Appl. No.: 12/989,418

(22) PCT Filed: Apr. 23, 2008
(86) PCT No.: PCT/SG2008/000136

§ 371 Date: Oct. 24, 2010

(51) Int. Cl. G02B 26/00; G02B 3/14; G02B 15/00

(52) U.S. Cl. 359/290; 359/666; 359/676

(57) ABSTRACT

A variable optical system comprises a variable optical assembly including a plurality of deformable layers, selectively operable to vary at least one of: an optical property of at least one of the layers, a physical property of at least one of the layers, and an optical performance of the assembly, while maintaining a constant mass in each layer, wherein each layer has an optical function. A constant volume may be maintained in each layer depending on the material used in each layer. Arrangements employing various combinations of materials forming the optical assembly and other optical systems and components are disclosed.

### BACKGROUND

1. Technical Field

Embodiments of the invention relate to variable optical systems employing combinations of deformable materials, and mounting arrangements thereof to vary optical properties of the materials and/or optical performance of the optical system.

2. Description of Related Art

A common type of variable focus system involves multiple solid lenses in which relative distances between two or more lenses can be varied to alter the focal length of the lens system. A drawback of this system is the relatively large form factor which limits the size of a device incorporating the variable focus system.

With increasing demand for miniaturized devices, an optical system having smaller form factor and improved performance is desired.

### SUMMARY OF EMBODIMENTS OF THE INVENTION

Embodiments of the invention relate to a variable optical system whose optical properties and/or performance are varied by controlling a deformation of one or more layers forming an optical assembly in the optical system, or by providing a suitable stimulus. Examples of optical properties include, but are not limited to, refractive index, transmission coefficient, dispersion coefficient, polarization, and stretchability. Examples of optical performance include, but are not limited to, focal length, optical power, reflective performance, refractive performance, polarization, spot size, resolution, modulation transfer function (MTF), distortion, and diffractive performance.

The optical assembly comprises a plurality of deformable layers, where one or more layers is/are selectively operable to vary an optical property of the layer(s) and/or to vary an optical performance of the optical system while maintaining a relatively constant mass in each of the layers. A constant volume may be maintained in each layer formed of incompressible material. The volume may be varied in each layer formed of compressible material. Each layer, including an outermost of the layers, has an optical function and may be selectively deformed independent of or dependent on another layer. The outermost layer may be operable to induce a uniform or a non-uniform thickness. One or more layers may be operable to induce a convex, a concave, an even sphere, or an odd sphere, or other type of optical surface.

Various combinations of deformable materials, e.g. elastomeric/elastic materials and flowable materials, may form the optical assembly. The optical assembly may also include one or more inelastic materials as an optical element. To control a deformation of one of the layers, an appropriate actuator may be coupled to the layer/material to be deformed.

Embodiments of the invention are particularly advantageous in providing a variable optical system having a small and compact form factor without compromising performance of the system.

### BRIEF DESCRIPTION OF THE DRAWINGS

FIGS. 1A to 1E illustrate examples of deformations resulting in changes in shape and/or thickness of a variable optical assembly.

FIGS. 2A to 2G illustrate examples of possible arrangements of elastomeric materials, flowable materials, Frenel lens, or a combination thereof in various optical assemblies.

FIG. 3A is a side cross-sectional view of a piezo actuator coupled to an outermost layer of a variable optical assembly.

FIG. 3B is a partial top view of FIG. 3A.

FIG. 3C is a side cross-sectional view of a piezo actuator coupled to an outermost layer of another variable optical assembly.

FIGS. 3D to 3G are side views of various stacked actuators.

FIGS. 3H to 3I illustrate examples of a corrugated surface on a substrate.

FIGS. 3J to 3L illustrate examples of possible arrangement of a piezo actuator coupled to a variable optical assembly.

FIG. 3M is a cross-sectional view of a variable optical assembly mounted on a voice coil motor (VCM).

FIGS. 4A to 4C illustrate an optical assembly with possible deformation.

FIGS. 4D to 4F illustrate various adjustable parameters of an optical assembly.

FIGS. 5A to 5C illustrate various views of an optical system for varying an aperture size.

FIG. 5D to 5E illustrate another variable optical system for varying an aperture size.

FIG. 5F illustrates the variable optical system of FIG. 5D having polarizers disposed in cooperation with the variable optical system.

FIG. 5G illustrates yet another variable optical system for varying an aperture size.

FIG. 5H illustrates another variable optical system in cooperation with a polarizer.

FIGS. 6A to 6B illustrate examples of a variable waveguide.

FIGS. 6C to 6D illustrate examples of a variable interferometer.

FIG. 6E-6F illustrate examples of an add-drop multiplexer.

FIGS. 7A to 7C illustrates examples of a variable prism.

FIGS. 8A to 8D illustrate various views of a variable optical filter and an deformation thereof.

FIGS. 9A to 9B illustrate a variable reflector system and a deformation thereof.

FIGS. 10A to 10D illustrate a variable Fresnel lens system and deformations thereof.

FIG. 10E illustrates another example of a variable Fresnel lens system.

FIGS. 11A to 11J illustrate various combinations employing a Fresnel lens and a variable optical system.

FIGS. 12A to 12E illustrate examples of a variable optical system having variable gratings and a deformation thereof.

FIG. 13A to 13C illustrate examples of a tunable add-drop multiplexer system.

FIGS. 14A to 14E illustrate various arrangements of variable optical systems.

FIG. 15 illustrates a shape-changing mirror.

FIG. 16 illustrates a variable optical system with tunable non-reflective properties.

FIGS. 17A to 17D illustrate examples of a deformable grating light modulator (DGM) and deformations thereof.

FIGS. 18A to 18D illustrate examples of a variable reflective prism.

FIGS. 19A to 19F illustrate a variable Fabry-Perot interferometer and deformations thereof.

FIGS. 19G to 19J illustrate possible deformation of the variable Fabry-Perot interferometers of FIGS. 19A to 19F.

FIG. 20 illustrates a tunable IR Fabry-Perot interferometer.

FIGS. 21A to 21C illustrate various combinations employing the variable optical system of FIG. 14C.

FIG. 22 illustrates a light guide employing multiple optical assemblies.

FIG. 23 illustrates a graded layered lens system.

### DETAILED DESCRIPTION OF ILLUSTRATIVE EMBODIMENTS

In the following description, numerous specific details are set forth in order to provide a thorough understanding of various illustrative embodiments of the present invention. It will be understood, however, to one skilled in the art, that embodiments of the present invention may be practiced without some or all of these specific details. In other instances, well known process operations have not been described in detail in order not to unnecessarily obscure pertinent aspects of embodiments being described. In the drawings, like reference numerals refer to same or similar functionalities or features throughout the several views.

Embodiments of the invention relate to a variable optical system operable to vary its optical properties and/or optical performance. The variable optical system may include a variable optical assembly formed of multiple layers overlaying one another in a juxtaposed arrangement, where each layer has an optical function. One or more layers may be selectively operable independent of or dependent on an other layer to vary an optical property of the layer and/or an optical performance of the optical system. The optical assembly includes an outermost layer forming a membrane at least partially enclosing the inner layer(s). The outermost layer is disposed to receive an incident optical beam entering the optical assembly and may include a variable optical surface or region deformable in any degree between a convex and a concave shape. By controlling a deformation of one or more layers in the optical assembly, an optical performance, including but not limited to, focal length, optical power, reflective performance, refractive performance, polarization, spot size, resolution, modulation transfer function (MTF), distortion, and diffractive performance, of the variable optical system may be varied as required. Deformation of the layer(s) may change the shape/and or thickness of the layer(s) while maintaining a constant mass in the layer(s). In the following embodiments described, the volume of one or more layers may remain constant if the layer(s) (elastomeric and/or flowable materials) are formed of incompressible materials. Alternatively, the volume of one or more layers may be changed or varied if the layer(s) (elastomeric and/or flowable materials) are formed of compressible materials. By providing a suitable stimulus (e.g. by coupling a stimulator) to one or more layers in the optical assembly, an optical property, including but not limited to, refractive index, polarization, light transmission coefficient, dispersion power, and stretchability, may be varied as required. In the following embodiments, a suitable stimulus includes, but are not limited to, heat, light, electromagnetic radiation, stress, pressure, magnetic field, electric field, humidity, target analyte, gas, and biological organism.

In certain embodiments, the variable optical assembly may be formed of a single deformable layer having an optical function, wherein the layer is operable to vary an optical property and/or an optical performance of the layer while maintaining a constant mass in the layer. The single layer may be coupled to an actuator for controlling a deformation of the layer to selectively induce a convex, a concave, an even sphere or an odd sphere optical surface therein to vary its optical performance. The single layer may also receive a suitable stimulus to vary its optical property.

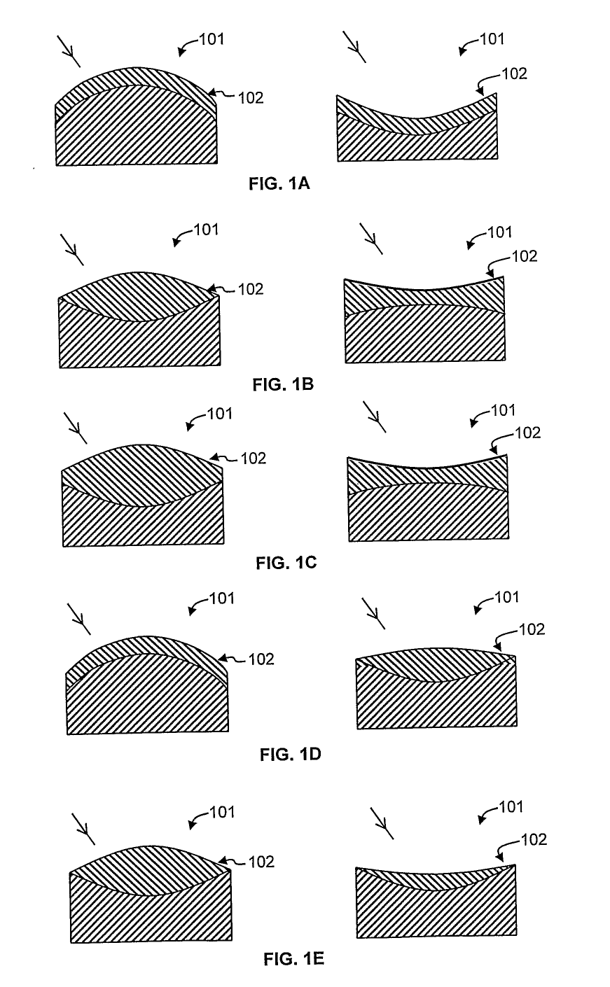

Deformation of one or more layers of the optical assembly may result in various shapes and configurations. The variable optical assembly, as a whole, may take on any suitable shapes as required including, but are not limited to, convex, concave, circular, elliptical, square, rectangle and polygon. An outermost layer may include a variable optical region deformable between a substantially uniform thickness and a non-uniform thickness. FIG. 1A illustrates an example in which a variable optical assembly 101 undergoes a deformation in shape between plano-convex and plano-concave, while an outermost layer 102 preserves its uniform thickness. FIG. 1B illustrates an example in which a variable optical assembly 101 undergoes a deformation in thickness and shape, and more particularly, the outermost layer 102 of the lens assembly changes between a biconvex shape and a biconcave shape, both having non-uniform thicknesses. FIG. 1C illustrates an example similar to FIG. 1B, and more particularly, the outermost layer has an edge thickness before and after deformation. FIG. 1D illustrates an example in which the variable optical assembly 101 undergoes a deformation in thickness, and more particularly, the outermost layer 102 changes between a convex-concave shape having a substantially uniform thickness, and a biconvex shape having a substantially non-uniform thickness. FIG. 1E illustrates an example in which the variable optical assembly undergoes a deformation in thickness and shape, and more particularly, an optical surface of the outermost layer 102 changes between a bi-convex shape in the outermost layer 102 having a convex-concave shape respectively, both having a non-uniform thickness.

FIGS. 1A to 1E also illustrate optical beams being incident on an outermost layer 102 of a variable optical assembly 101. While FIGS. 1A to 1E illustrate examples of possible deformation of a variable optical assembly 101, it is to be understood that embodiments of the invention are not to be limited to these examples.

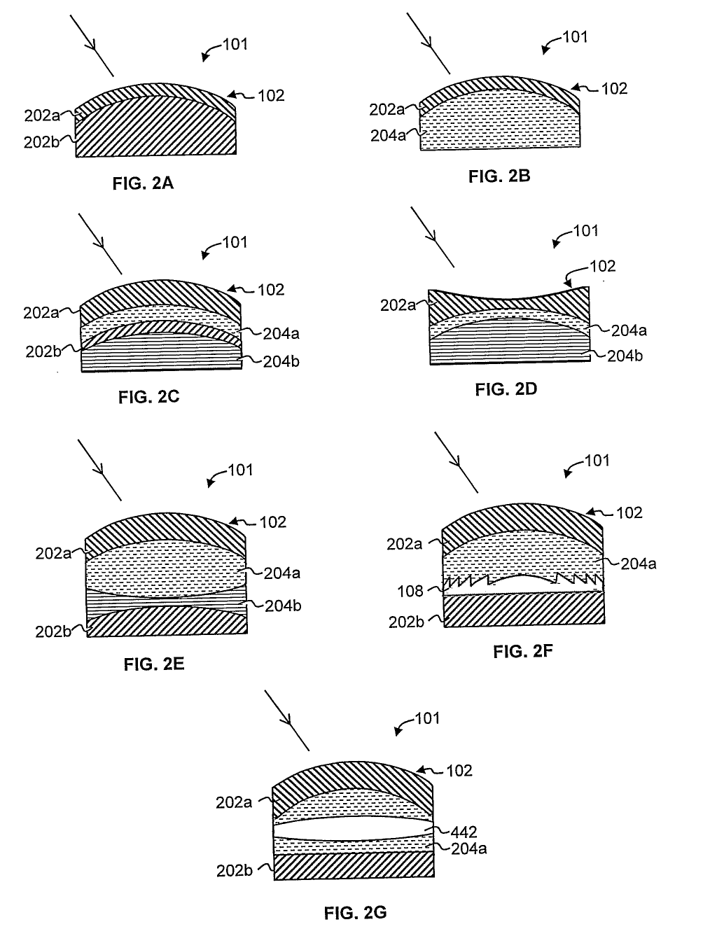

Various types of materials may be employed in the variable optical assemblies using various arrangements. The multiple layers of the variable optical assembly may include a plurality of deformable materials, e.g., elastomeric/elastic materials, flowable materials. Depending on requirements, the multiple layers of the variable optical assembly may also include an inelastic/fixed material employed in combination with the deformable materials. Various arrangements of various combinations of materials are illustrated in FIGS. 2A to 2G.

FIG. 2A illustrates an optical assembly 101 formed from two layers of elastomeric materials 202a, 202b arranged in a juxtaposed arrangement. The elastomeric/elastic material (hereinafter referred to as “elastomeric material”) selected for use in embodiments of the invention should be stretchable, and/or flexible, and/or pliant, and/or yielding, and/or rubbery, and/or resilient, and/or capable of deforming under tensile and/or compressive stress. The elastomeric material may or may not be capable of returning to an original condition after deformation. The elastomeric materials can possess any desired level of optical transparency as required. Depending on requirements, a same elastomeric material may be employed in two or more layers of the variable optical assembly. Alternatively, different elastomeric materials may be employed in the multiple layers of the optical assembly. The elastomeric materials 202a, 202b may have same or different refractive indices, thickness, shapes, dispersion coefficients, transmission coefficient, stretchabilities, or a combination thereof.

FIG. 2B illustrates an optical assembly 101 formed of two layers including an elastomeric material 202a and a flowable material 204a arranged in a juxtaposed arrangement. The flowable material selected for use in embodiments of the invention may be provided in a liquid, or gaseous, or semi-solid (gel) state having fluidic properties. Alternatively, the flowable material may be provided in a solid state but configured to possess a fluidic property during operation of the optical assembly, such as by applying a suitable stimulus, e.g. heat, light, electromagnetic radiation, stress, pressure, magnetic field, electric field, humidity, target analyte, gas, and biological organism. One example of a flowable material is a liquid crystal. The elastomeric and flowable materials may have same or different refractive indices, thickness, shapes, dispersion coefficients, transmission coefficient, stretchabilities, or a combination thereof.

FIG. 2C illustrates an optical assembly 101 in which several elastomeric materials 202a, 202b and flowable materials 204a, 204b are disposed in an alternating arrangement. Depending on requirements, the elastomeric materials may employ same or different materials. Similarly, the flowable materials may employ same or different materials. FIG. 2D illustrates an optical assembly 101 in which an elastomeric material 202a overlays an arrangement formed of two flowable materials 204a, 204b. In the example of FIG. 2D and other arrangements where the flowable layers 204a, 204b are disposed adjacent each other, the adjacent flowable layers 204a, 204b may employ different materials which are immiscible. FIG. 2E illustrates an optical assembly in which an arrangement formed of two flowable materials 204a, 204b is interposed between two elastomeric materials 202a, 202b. FIG. 2F illustrates an optical assembly in which a Fresnel lens 108 is interposed between two layers, e.g. flowable material 204a and elastomeric material 202a. FIG. 2G illustrates an optical assembly in which an air pocket 442 is provided in the flowable material 204a to increase an optical power of the optical assembly. The illustrations of FIGS. 2A to 2G should not be construed in a limiting sense as other combinations incorporating any of the above arrangements are possible. For example, inelastic or fixed lens may also be employed with any of the above arrangements as required with suitable modifications.

To control a deformation of one or more layers of an optical assembly, a suitable actuation system may be employed. Examples of actuation systems and methods include, but are not limited to, piezo actuator, voice coil motor, electromagnet actuator, thermal actuator, bi-metal actuator, and electrowetting devices. In an optical assembly having multiple layers, one or more actuators may be employed to control the deformation of the layers depending on whether independent or dependent control of the layers is desired.

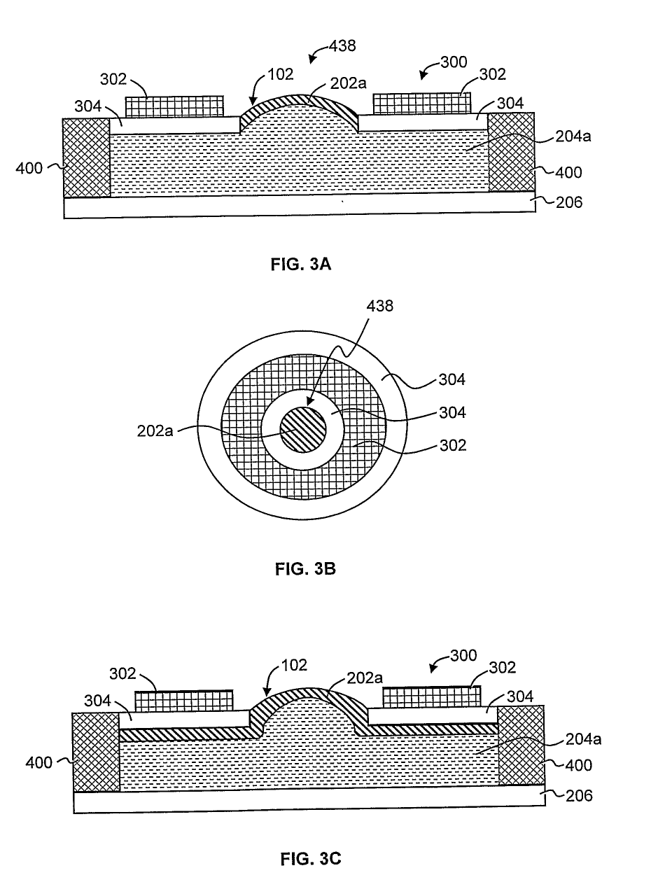

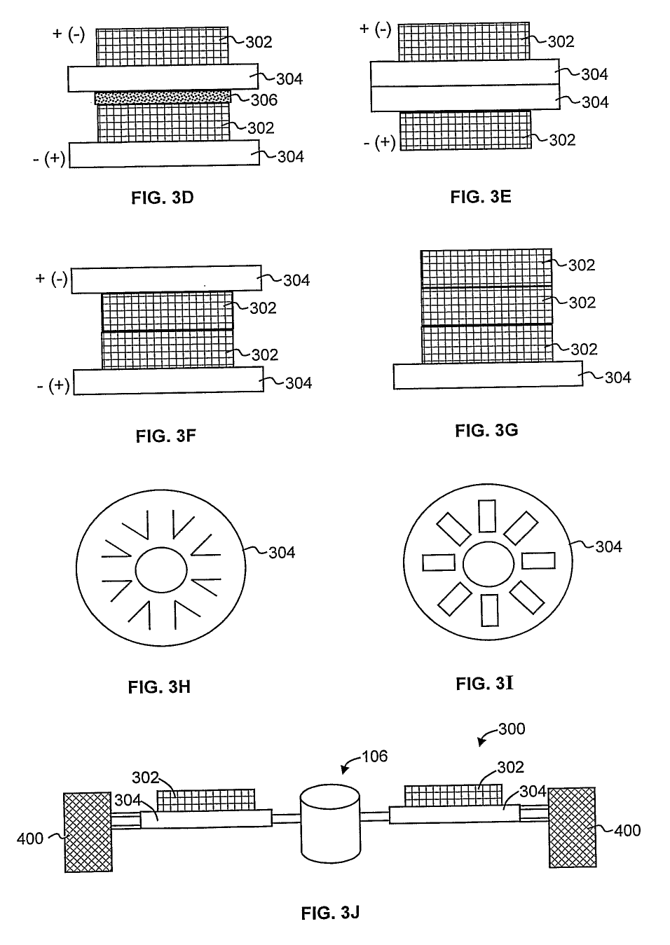

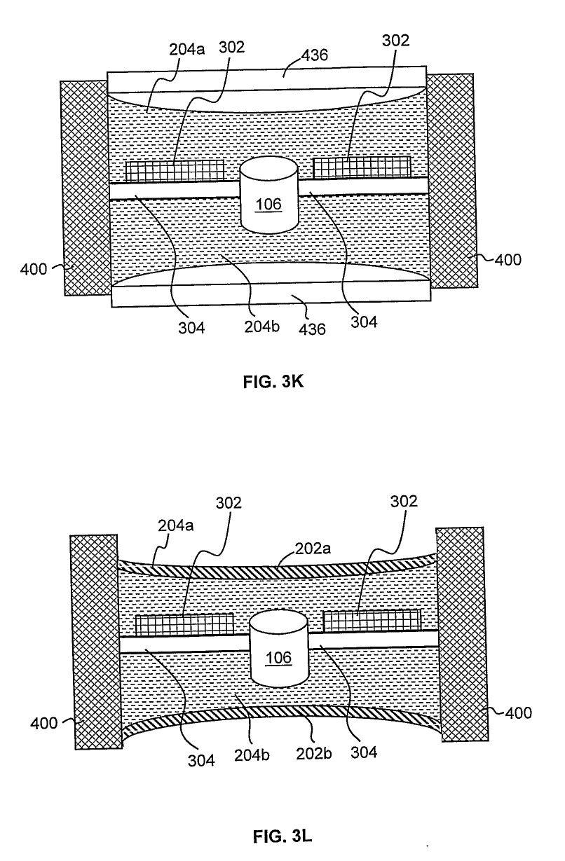

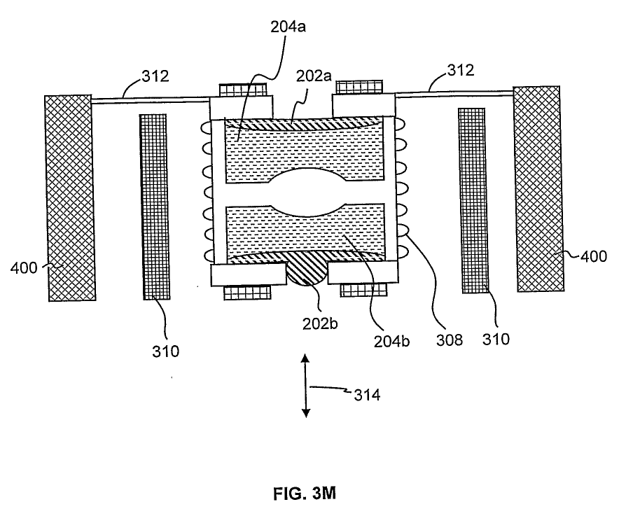

According to an embodiment of the invention, a first actuator may be provided and coupled to one or more layers for deforming the layer(s) coupled thereto. More particularly, the first actuator may be coupled to an outermost layer 102 at its peripheral edge to exert a radial tensile or compressive stress. Reference is made to FIG. 3A illustrating a side cross-sectional view of a piezo actuator 300 coupled to an optical assembly having an outermost layer 102 formed of an elastomeric material 202a and inner layers formed of a flowable material 204a and, a lens or transparent substrate 206. The piezo actuator 300 may include a piezo material 302 mounted on a substrate 304 (e.g. metal, plastic, etc.) which is coupled to the outermost layer 102 of the lens assembly. The substrate 304 may also be coupled to a housing 400 of the variable optical system for support. Upon activation of the piezo actuator 300, a displacement is induced in the substrate 304 which in turn deforms the outermost layer (102 and/or 202a) while maintaining constant mass of flowable material 204a enclosed. Reference is made to FIG. 3B illustrating a top view of the piezo actuator 300 of FIG. 3A. In FIG. 3B, an aperture 438 leads to the elastomeric material 202a disposed therein. The piezo material 302 may be provided in an elliptical, circular, rectangular, or any other shapes, having an opening therethrough for disposing the optical assembly. FIG. 3C illustrates another example of a piezo actuator 300 similar to FIG. 3A, but the elastomeric material 202a is interposed between the substrate 304 and flowable material 204a.

If required, a second actuator may be provided and coupled to another layer of the lens assembly to independently control the deformation of this other layer. Depending on requirements, further actuators may be provided and coupled to any other selected layers to independently/complementarily control the deformation of the other selected layers.

In certain embodiments where a higher deflection of the actuating substrate 304 is desired to induce greater deformation, the piezo actuator may be provided in the form of a stacked piezo actuator. In the stacked actuator of FIG. 3D, piezo materials 302 and actuating substrates 304 are disposed in an alternating manner. More particularly, an actuating substrate is coupled to an adjacent piezo material by an adhesive 306 or other known methods. In the stacked actuator of FIG. 3E, multiple actuating substrates 304 are coupled together, such as by an adhesive or other known methods, which are in turn interposed between multiple piezo materials 302. In the stacked actuator of FIG. 3F, multiple piezo materials 302 are coupled together, which are in turn interposed between multiple actuating substrates 304. In the stacked actuator of FIG. 3G, multiple (e.g. three) piezo material are coupled together which are mounted on or coupled to an actuating substrate 304.

In other embodiments, the actuating substrate 304 may include a corrugated surface to increase mechanical amplification of the actuating substrate 304. The actuating substrate 304 may be bonded to the piezo material by an adhesive. Examples of corrugated surfaces are illustrated in FIGS. 3H and 3I.

Alternative to using a piezo material 302, other actuating materials, such as, a shape memory alloy, an artificial muscle, an ion-conducting polymer or any material which can change its shape or induce stress/strain due to application of a stimulus may be used.

In addition to actuator(s) for controlling deformation of one or more layers of the optical assembly 106, a further (or third) actuator 300 may be coupled to an entire variable optical assembly 106 to move the assembly along its optical axis or in any other directions as required. Reference is made to FIG. 3J illustrating an arrangement in which the entire optical assembly is coupled to a third actuator 300. The optical assembly is coupled to a substrate 304 of the third actuator 300 for inducing a displacement of the optical assembly. The substrate 304 may also be supported by a housing 400 of the variable optical system using suitable coupling supports. The variable optical assembly labelled as 106 in FIG. 3J may be any of the assemblies illustrated in FIGS. 1A-1E, 2A-2G, 3A-3M, 5A-5G, or any other configuration described herein.

FIG. 3K illustrates an arrangement in which an actuator 300 is coupled to a variable/fixed optical assembly 106 to control its movement and/or deformation of the optical assemblies. The actuator 300 may be further coupled to one or more layers of flowable materials 204a, 204b juxtaposed to the optical assembly 106 to control a deformation of the layer(s). In this example, when the actuator moves the optical assembly 106, a deformation is induced in the flowable materials while maintaining a constant mass of the flowable materials. Covers 436 may be provided to protect the flowable materials 204a, 204b from the environment. FIG. 3L illustrates a similar arrangement to FIG. 3K. In FIG. 3L, however, an elastomeric material 202a, 202b is juxtaposed with a flowable material 204a, 204b.

FIG. 3M is a cross-sectional view of a variable optical assembly 106 mounted on a voice coil motor (VCM) for controlling the movement 314 of the variable optical assembly along its optical axis. The variable optical assembly 106 may be disposed within electrical conductive coils 308 (electromagnet) which in turn is interposed between permanent magnet rings 310. The variable optical assembly 106 may be coupled to a housing 400 by springs 312 to restrain the movement 314 of the variable optical assembly 106.

In certain embodiments, electrowetting may be used to control a deformation of the layers, e.g. elastomeric material, or flowable material or a combination thereof. For this purpose, the layers should be electrically conductive. The electrically conductive layer(s)/electrode(s) are coupled to a dielectric material which in turn is coupled to a conductive flowable material. When an electric field is applied to the conductive flowable material, a contact angle between the conductive flowable material varies to control the deformation of the layer(s)/electrode(s).

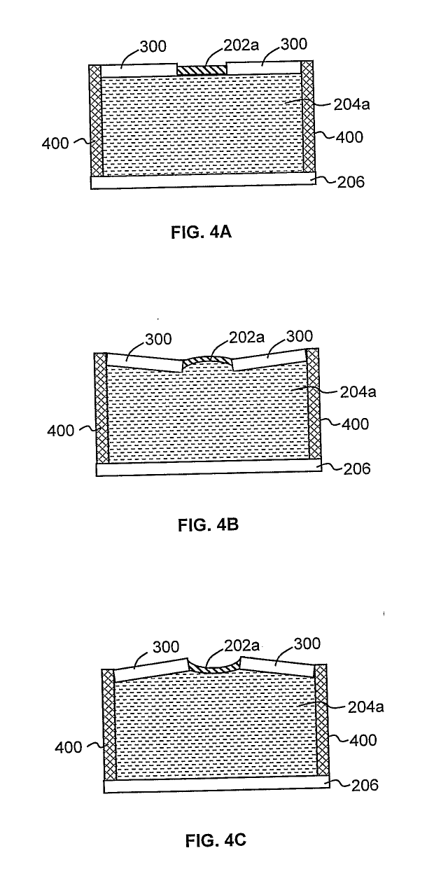

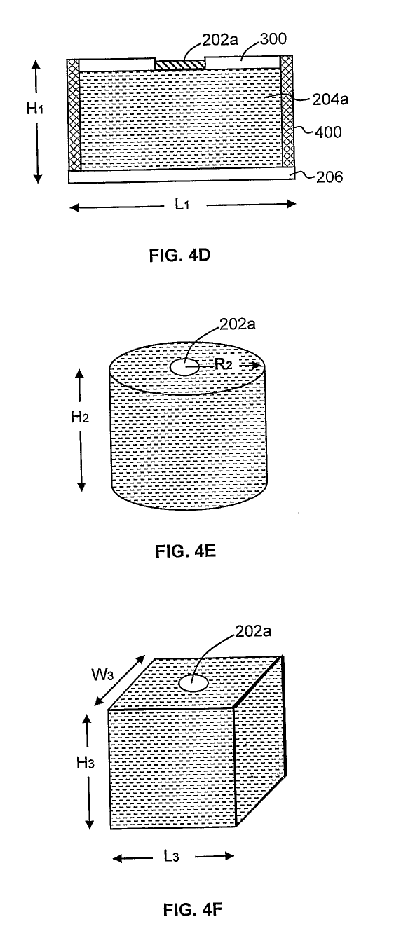

FIG. 4A illustrates an optical (lens) system having a layered arrangement formed of an outer elastomeric material 202a and an inner flowable material 204a according to one embodiment of the invention. The elastomeric material 202a is coupled to an actuator 300 for controlling a deformation of the elastomeric material 202a. The flowable material 204a is enclosed by the actuator 300, a housing 400 of the optical system and a transparent substrate/lens 206 disposed remotely from the elastomeric material 202a. Both the elastomeric 202a and flowable materials 204a have an optical function. Upon activating the actuator 300, a movement in the actuating substrate induces an appropriate deformation in the elastomeric 202a and flowable materials 204a to maintain relatively constant mass of the flowable material 204a. FIG. 4B illustrates a deformation in the flowable material inducing a convex shape in the elastomeric material to form a convex lens while the volume of the flowable material 204 remains relatively constant. FIG. 4C illustrates a deformation in the flowable material inducing a concave shape in the elastomeric material to form a concave lens while the volume of the flowable material 204a remains relatively constant.

In order to deform the various layer/materials while maintaining their constant mass and/or volume, various physical parameters of the optical assembly may be varied. FIGS. 4D, 4E and 4F are simplified views of an optical assembly to illustrate various adjustable parameters of an optical assembly. By suitably coupling an actuator to the optical assembly, the height (H1, H2, H3), length (L1, L3), width (W3), radius (R2), or a combination thereof may be varied or deformed to change the shape of the outermost layer (e.g. lens) while the volume of the inner layer remains constant.

According to one embodiment of the invention, an optical property an/or physical property, e.g., refractive index, light transmission coefficient, absorption coefficient, dispersion power, polarization and stretchability of one or more layers forming an optical assembly may be varied. To this purpose, a suitable stimulus, e.g. heat, light, electromagnetic radiation, magnetic field, or electric field, or a combination thereof may be applied to selected layer(s).

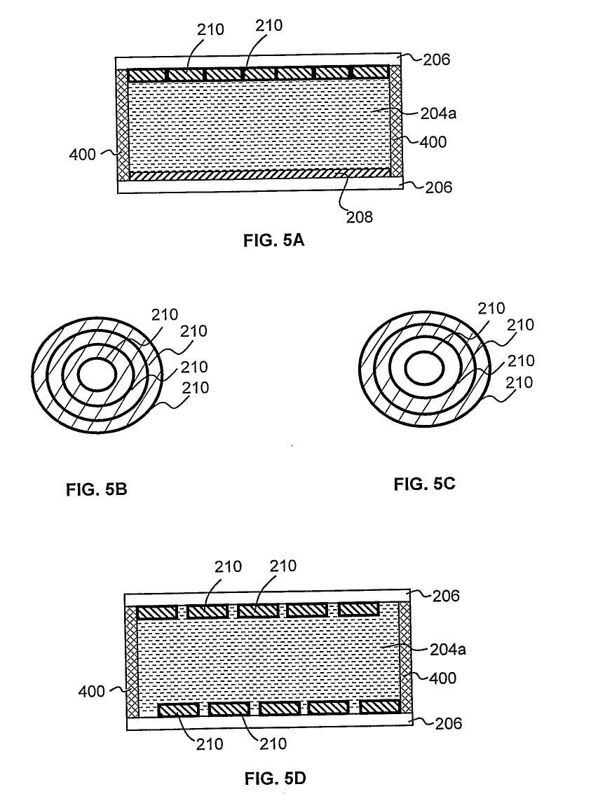

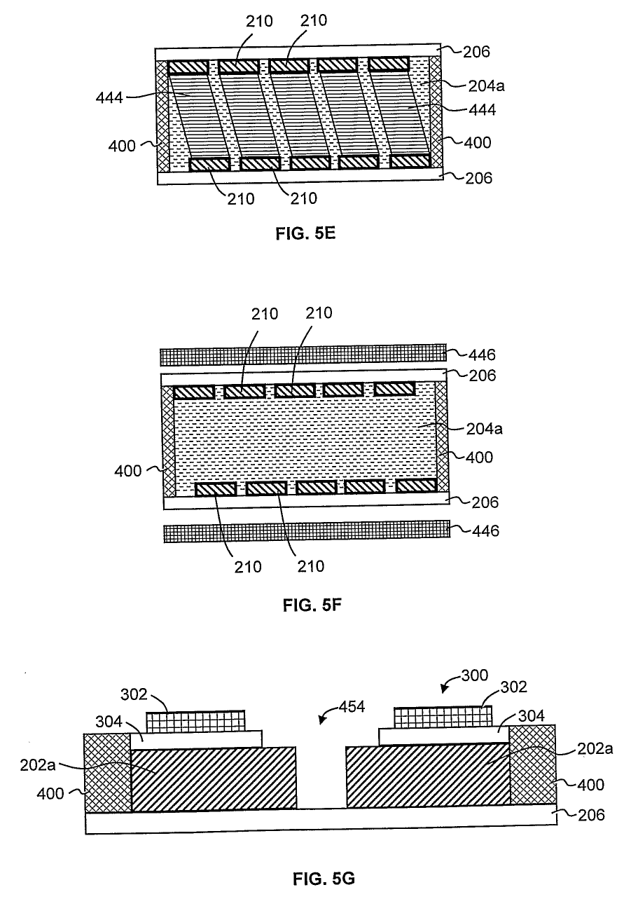

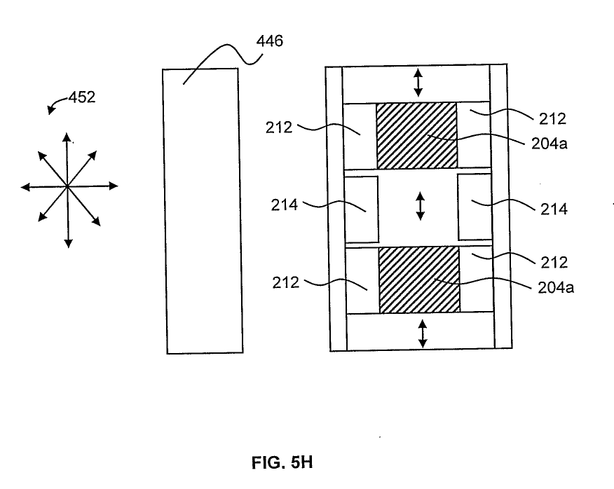

FIGS. 5A-5F illustrate various views of an optical system for varying an aperture size by varying the light transmission coefficient or polarization of a material. FIG. 5A illustrates a side view of a variable optical assembly having a layered arrangement formed of a first top transparent substrate 206 (e.g. an elastomeric/inelastic material) overlaying a second layer of transparent electrode rings 210, which in turn overlays a third layer of flowable material 204a, e.g. liquid crystal, which in turn overlays a fourth layer of transparent electrode 208, which in turn overlays a fifth layer of transparent substrate 206. The second layer of transparent electrode rings 210 may be individually or separately activated by applying a suitable stimulus to vary a light transmission coefficient or direction of light polarization of the flowable material 204a and thereby controlling the size of the aperture. Suitable stimulus includes, but are not limited to, electric field and electric potential. FIGS. 5B-5C illustrate top views of the optical assembly of FIG. 5A having a small aperture and an enlarged aperture respectively, by selectively activating the electrode rings 210. This may be alternatively considered as a light valve.

FIGS. 5D and 5E illustrate a variable optical assembly which may used as an electrically-controlled optical shutter or aperture. The variable optical assembly includes a layered arrangement formed of a first and a second layer of transparent concentric electrode rings 208 (e.g. indium tin oxide, ITO) interposing a flowable material 204a, e.g. a liquid crystal, therebetween. The first and the second layers of electrode rings are arranged at an offset relative to each other. The layers of electrode rings 208 are to receive a stimulus, e.g., electric potential, electric field, to vary a light transmission coefficient and/or direction of light polarization of the flowable material to vary an aperture size. FIG. 5D illustrates an inactive or OFF state in which light may pass through the layers of electrode rings 208 and flowable material 204a. FIG. 5E illustrates an active or ON state in which certain regions 444 in the flowable material 204a is rendered optically opaque, e.g. opaque to polarized light in a certain direction. The opaque regions are arranged with a slant or at an angle to prevent light transmission through the flowable material 204a between adjacent electrodes 208. The regions 444 in the flowable material 204a between adjacent electrodes 208 may be rendered opaque, e.g. opaque to polarized light in a certain direction, by applying an electric potential or electric field between the layers of electrode rings 208. The aperture may also be provided as a TFT (Thin Film Transistor) display. The aperture size may be varied by controlling the TFT pixels in the TFT display. For this purpose, the concentric rings in various sizes may be provided to achieve the variable aperture.

In certain embodiments, one or more polarizers 446 may be arranged to polarize light beams entering the optical assembly of FIGS. 5A, 5D and 5E. FIG. 5F illustrates the arrangement of FIGS. 5D, 5E having polarizers arranged in cooperation with the optical assembly.

FIG. 5G illustrates an optical system for varying an aperture size. In FIG. 5G, a single opaque elastomer 202a is provided in the optical assembly and coupled to an actuator 300. An aperture 454 is provided by an opening in the elastomeric material 202a. By controlling a deformation of the elastomeric material 202a using the actuator, the elastomeric material 202a may be expanded or contracted to vary the aperture size.

FIG. 5H illustrates a variable optical system disposed in cooperation with a polarizer. The variable optical system includes an optical assembly formed of a flowable material 204a (e.g. liquid crystal) and electrodes 212 disposed in cooperation with the flowable material 204a. The electrodes 212 may be selectively operable/activated by an application of a stimulus to change a polarization direction (as shown by the illustrated arrows) of a light beam being transmitted through the flowable material 204a while electrodes 214 may remain unactivated. A polarizer 446 may be disposed between the variable optical system and a light source 452 which may emit light in various directions. The polarizer may allow only polarized light (e.g. vertically polarized light) to enter the variable optical system.

According to one embodiment of the invention, a method of operating a variable optical system involves providing an optical assembly including multiple layers, each having an optical function. The layers may be operable to vary an optical property of one or more layers and/or to vary an optical performance of the optical assembly. For this purpose, one or more actuators may be coupled to one or more layers to control a deformation of the layer(s) coupled thereto to vary its optical properties and optical performance. A suitable stimulus may also be applied to one or more layers to control one or more optical properties and/or optical performance of the layer(s).

For illustrative purposes, various applications of embodiments of the invention are described in the following paragraphs with references to the accompanying drawings.

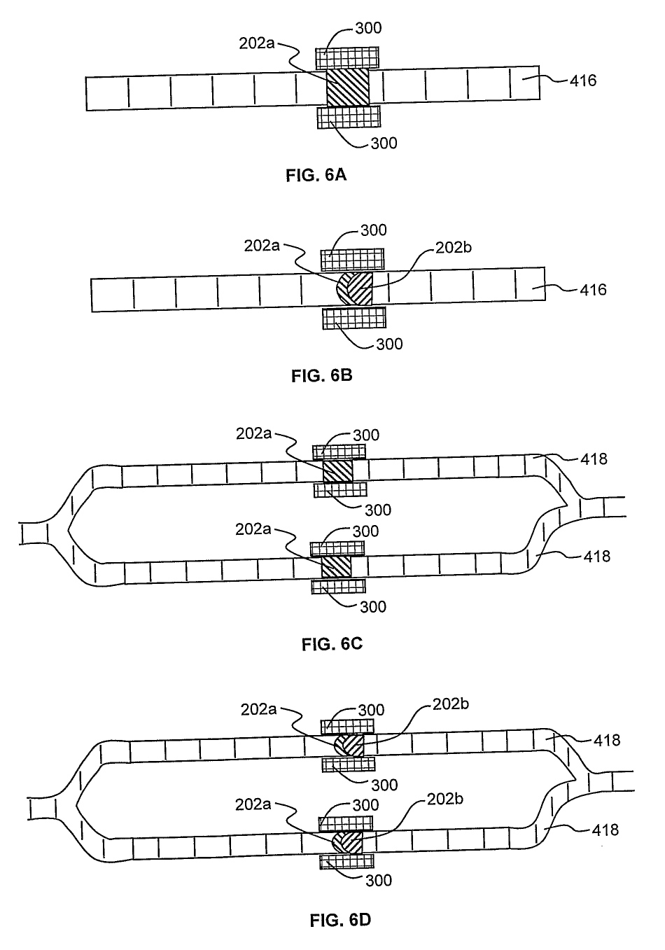

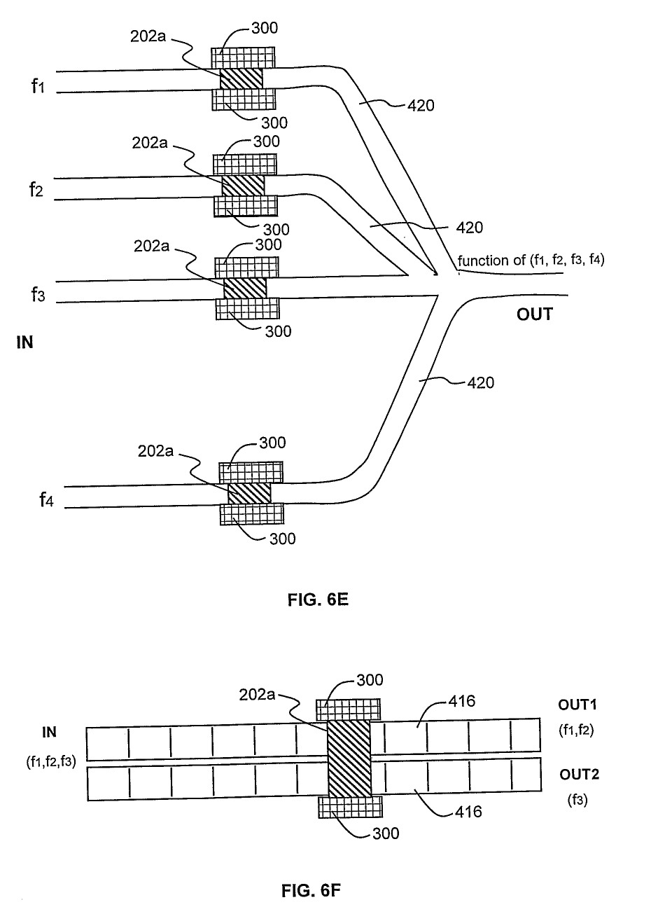

Reference is made to FIGS. 6A-6B illustrating variable waveguides having a variable optical (or Optical Path Difference, OPD) assembly to provide variable path lengths or variable path differences. The OPD assembly disposed in the waveguide may include an elastomeric material 202a (FIG. 6A), or flowable material 204a, or multiple elastomeric materials (FIG. 6B) or, a combination of at least one elastomeric material and at least one flowable material (FIG. 6B). The variable OPD assembly may be integrally incorporated along the wave guide material 416. Accordingly, one or more actuators 300 (or stimulator) may be appropriately incorporated in the waveguide to operate the OPD assembly. Deformation of the materials/layers may be an elongation or a contraction to change an optical path difference of a light beam transmitted therethrough. The deformation may induce a change in polarization of the materials/layers.

Reference is made to FIGS. 6C-6D illustrating dynamically tunable interferometers. An interferometer may employ a variable (OPD) assembly including a single elastomeric material (FIG. 6C), multiple elastomeric materials (FIG. 6B) or, a combination of at least one elastomeric material and at least one flowable material. The OPD assembly may be integrally disposed along each of the two arms 418 of the interferometer. One or more actuators 300 (or stimulator) may be appropriately disposed along each arm 418 to operate the OPD assembly. Deformation of the materials/layers may be an elongation or a contraction to change an optical path difference of a light beam transmitted therethrough. The deformation may induce a change in polarization of the materials/layers. If required, multiple variable OPD assemblies may be integrally disposed along each interferometer arm 418. The variable OPD assembly may be used as a sensor, by exposing the variable OPD assembly to different stimuli to achieve various optical path differences which will correspond to various properties of the stimuli of interest.

The arrangement of the OPD assembly and actuator as illustrated in FIG. 6C may be applicable, with suitable modifications, to an add-drop multiplexer which has two or more arms to receive independent or dependent inputs. FIG. 6E illustrates an add-drop multiplexer having multiple input arms 420 for receiving input optical beams at one or more frequencies (f1, f2, f3, . . . fn), and an output arm for transmitting an output optical beam as a function of the input optical beams including, but not limited to, function as of example: f(f1+f2+f3+ . . . +fn) and f(f1−f2+f3+ . . . +fn). An actuator may be coupled to at least one layer for controlling a deformation of the layer to change an optical path difference of a light beam being transmitted through the layer.

FIG. 6F illustrates another a waveguide having a variable optical coupling coefficients (or Optical Path Difference, OPD) assembly to provide variable path lengths or variable optical coupling coefficients. The OPD assembly may be disposed in multiple waveguide material 416 and may include an elastomeric material 202a, The OPD assembly may be integrally incorporated along multiple waveguide materials 416. Input optical beams at one or more frequencies, e.g. (f1, f2, f3) may be received by the waveguide to be transmitted through the OPD assembly, and various output optical beams produced at each waveguide material 416, e.g. OUT1(f1, f2) and OUT2(f3) as illustrated. One or more actuators 300 (or stimulator) may be appropriately incorporated to operate the OPD assembly. Deformation of the materials/layers may be an elongation or a contraction to change an optical path difference of a light beam transmitted therethrough. The deformation may induce a change in polarization of the materials/layers.

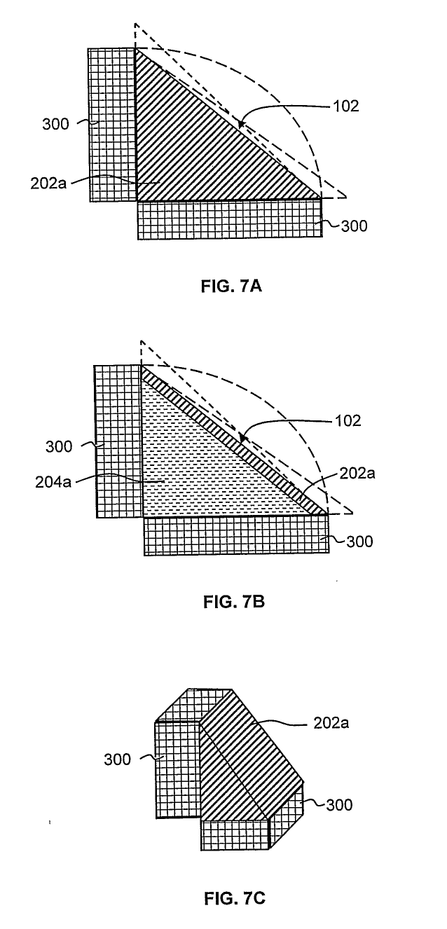

Reference is made to FIGS. 7A-7C illustrating variable prisms. A variable prism may employ a variable optical (prism) assembly including a single elastomeric material (FIG. 7A), or multiple elastomeric materials, or a combination of at least one elastomeric material and at least one flowable material (FIG. 7B). In the example of FIG. 7B, the variable prism may have a generally triangular base. An elastomeric material 202a forms an outermost layer 102 of the prism system while a flowable material 204a or another elastomeric material forms an inner layer. An actuator 300 may be coupled to at least the outermost layer 102 to control its deformation, e.g. to selectively vary an optical path of a light beam entering the prism FIGS. 7A-7B also illustrate possible deformation of the variable optical assembly 102 as indicated by dashed lines. FIG. 7C illustrates a perspective view of the variable prism of FIG. 7A.

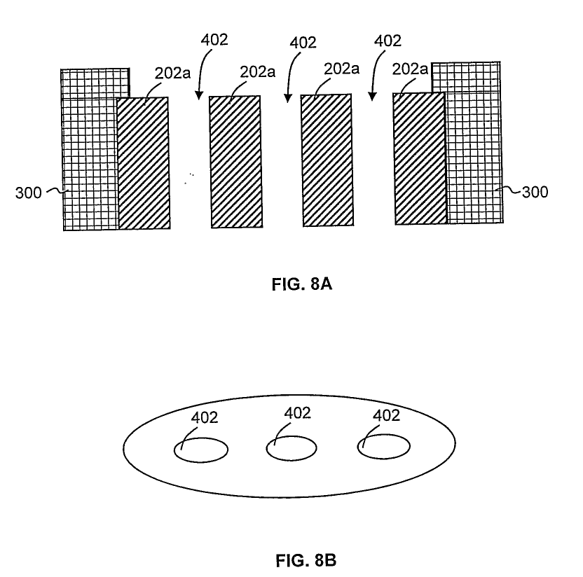

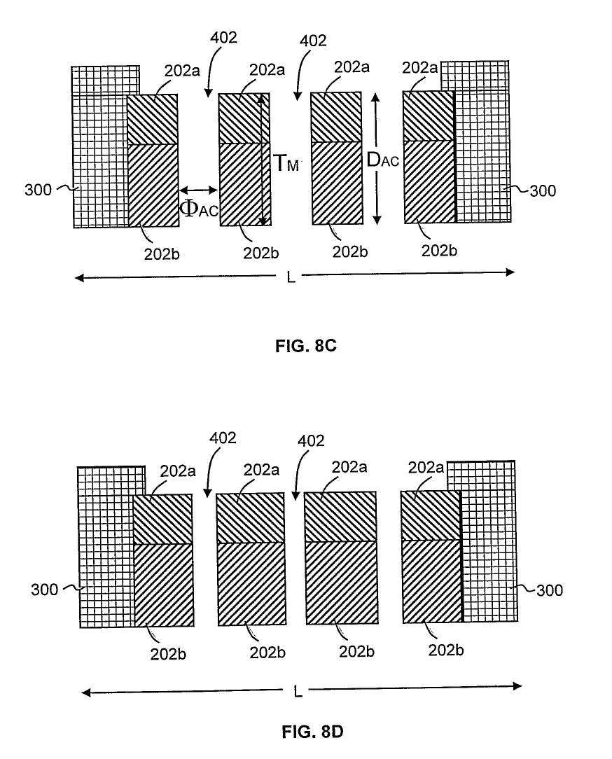

Reference is made to FIGS. 8A-8D illustrating cross-sectional views of a variable optical filters. A variable optical filter may employ a variable optical (filter) assembly including a single elastomeric material (FIG. 8A), multiple elastomeric materials (FIGS. 8B to 8D) or, a combination of at least one elastomeric material and at least one flowable material. The assembly may be formed of a block having spaced openings 402 perforated therethrough. In the example of FIGS. 8C-8D, the block may be formed of an integrated arrangement of multiple elastomeric materials 202a, 202b. Optionally, a dielectric coating may be provided on each side of the elastomeric materials 202a, 202b forming the walls of the air cavities or openings 402, or provided on the inner walls of the perforated through holes. Alternatively, the elastomeric materials may be made of a dielectric material. One or more actuators 300 may be coupled to the elastomeric materials 202a, 202b to control its deformation. Upon activation of the actuator 300, the thickness and/or shape of the elastomeric materials 202a, 202b may be controlled to vary the depth and/or diameter of the air cavities 402. The actuator is to vary a diameter and/or height of the openings to obtain a predetermined filtered wavelength for a light beam being transmitted through the optical filter. FIG. 8D illustrates the variable optical filter of FIG. 8C after activation of the actuator 300 decreases thickness (TM) of both elastomeric materials 202a, 202b to decrease the diameter (ΦAC) of the air cavities 402 while maintaining a length (L) of the optical filter constant. FIG. 8B is a top view of the variable optical filter of FIG. 8A. Further, an output filtered wavelength may be varied by application of a stimulus to one or more layers.

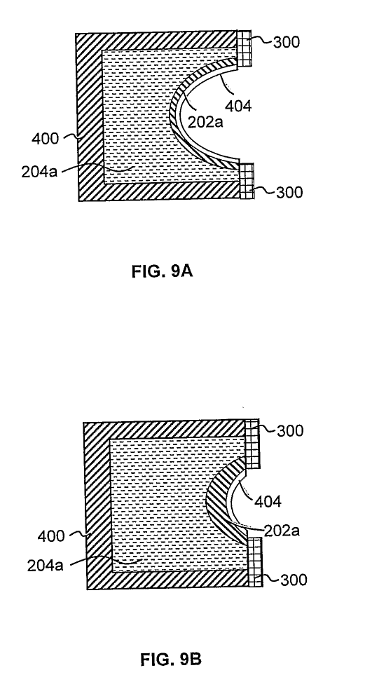

Reference is made to FIGS. 9A-9B illustrating cross-sectional views of a variable reflector system. A variable reflector system may employ a variable optical (reflector) assembly including multiple elastomeric materials, or a combination of at least one elastomeric material and at least one flowable material. In the example of FIG. 9A, the reflector assembly comprises a flowable material 204a and an outer elastomeric material 202a having an optical surface which is coated with a reflective material 404 so that an incident optical beam on the reflective material 404 may be fully, substantially or partially reflected. The elastomeric material 202a and flowable material 204a may be coupled to an actuator 300 for controlling a deformation of the materials. During operation of the variable reflector system and depending on requirements, the actuator 300 is activated in order to vary the shape (i.e. curvature) of the elastomeric material 202a and thereby inducing a change in the thickness and/or shape of the flowable material 204a. The actuation also varies a direction of a light beam incident on the reflective material 404. FIG. 9B illustrates an example of a change in the curvature of the elastomeric material 202a in the variable reflector system of FIG. 9A.

In certain embodiments, where multiple elastomeric materials are employed, various shapes of reflectors can be achieved, such as having an undulating/uneven reflecting surface. In other embodiments, at least one of the layers may be deformed by application of a stimulus to the layer(s).

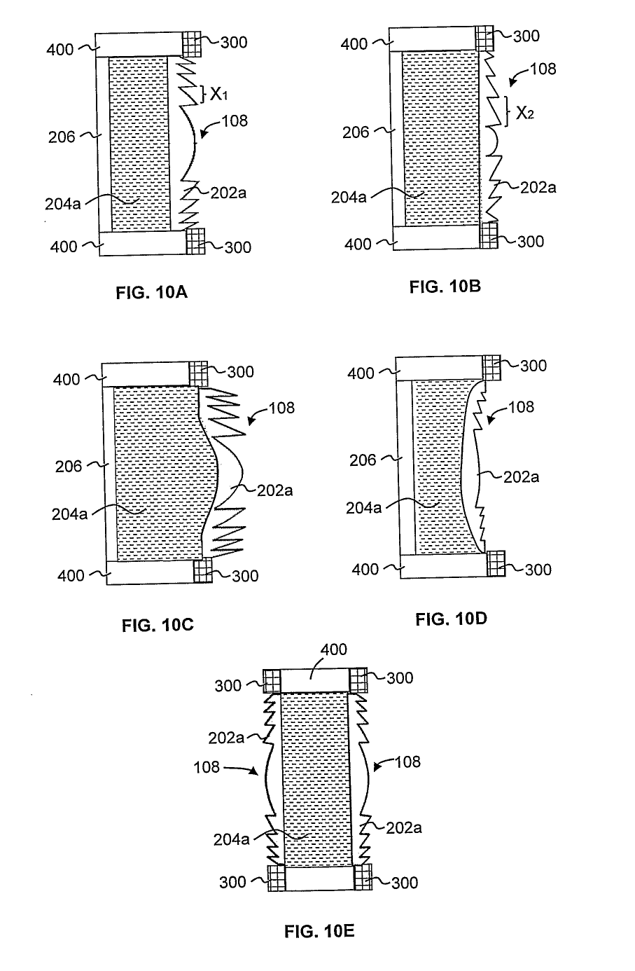

Reference is made to FIGS. 10A-10E illustrating a cross-sectional view of a variable Fresnel lens system. A variable Fresnel lens system may employ a variable optical (Fresnel lens) assembly including a single or multiple elastomeric materials or, a combination of at least one elastomeric material and at least one flowable material. In the examples of FIGS. 10A-10E, the variable Fresnel optical assembly includes a flowable material 204a and an outer elastomeric material 202a having an optical surface with gratings or concentric annular sections formed thereon, i.e. a Fresnel lens 108. The elastomeric material 202a may be coupled to an actuator 300 to control the thickness and/or shape of the lens system. A substrate 206, e.g. a transparent substrate, together with a housing 400, may also be provided to retain the flowable material 204a. During operation of the variable Fresnel lens system and depending on requirements, various parameters of the Fresnel lens system may be changed. Examples of such parameters include, but are not limited to, curvature of gratings, depth of gratings, length (pitch, X) of gratings and curvature of the Fresnel lens 108. FIG. 10B illustrates an example of an expansion or increase in pitch from X1 to X2 in the Fresnel lens system of FIG. 10A. FIG. 100 illustrates a Fresnel lens system being operably deformed to provide a convex shape in the Fresnel lens. FIG. 10D illustrates a Fresnel lens system being operably deformed to provide a concave shape in the Fresnel lens. FIG. 10E illustrates a Fresnel lens system in which two Fresnel lens interpose a variable optical assembly therebetween. In the variable Fresnel lens system described above, the Fresnel lens may have positive or negative Fresnel patterns, or a combination of both.

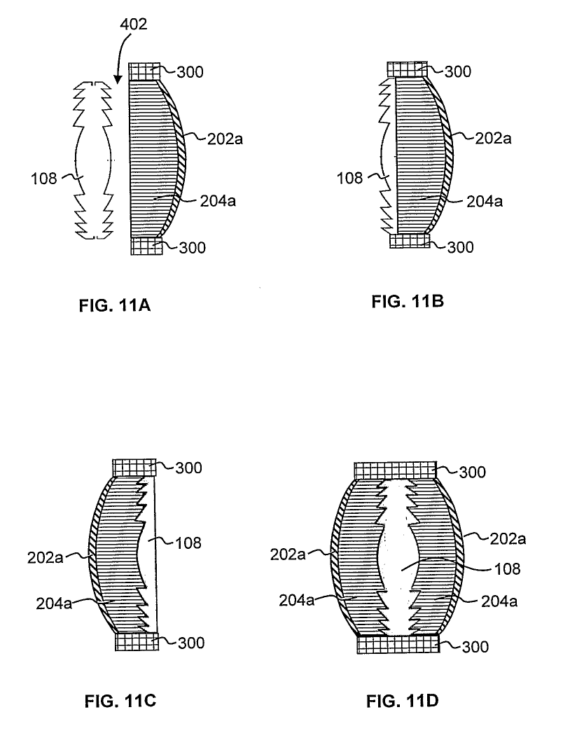

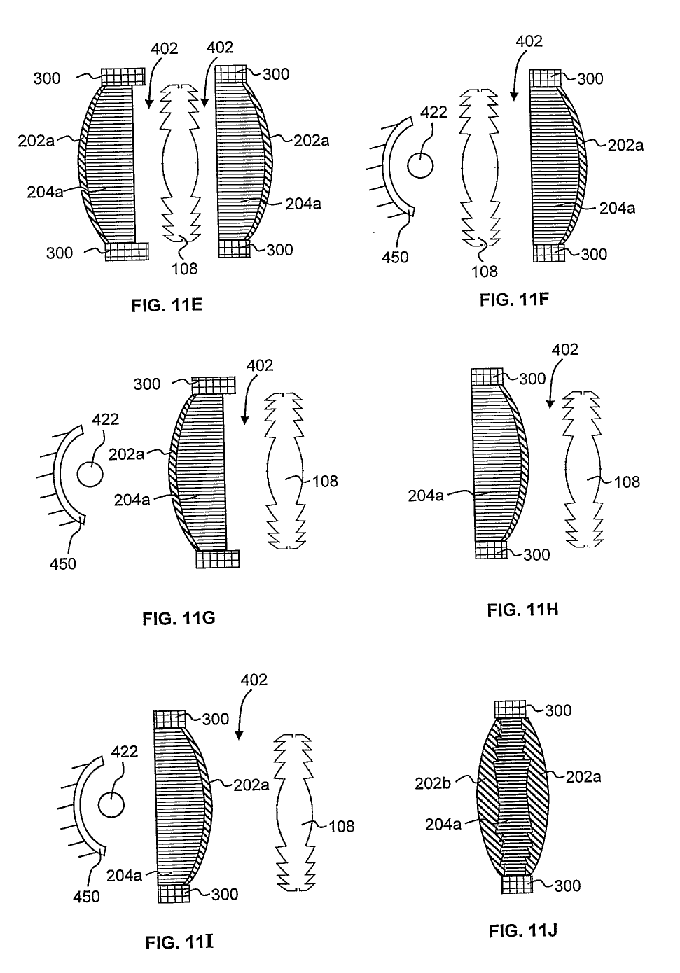

Reference is made to FIGS. 11A-11J illustrating cross-sectional views of a variable optical system comprising a Fresnel lens disposed in cooperation with a variable optical assembly. The Fresnel lens system may employ a fixed Fresnel lens or a variable optical (Fresnel lens) system. An example of a variable Fresnel lens system is illustrated in FIGS. 10A-10E. According to embodiments of the invention, the variable optical assembly may include at least one elastomeric material 202a and at least one flowable material 204a.

In the example of FIG. 11A, a fixed Fresnel lens 108 is spaced apart from the variable optical assembly by an air gap or other medium therebetween.

In the example of FIG. 11B, the variable lens assembly is disposed in juxtaposition with a fixed Fresnel lens 108 and remote from the gratings of the Fresnel lens 108. In the example of FIG. 11C, the variable optical assembly is disposed in juxtaposition with the Fresnel lens 108 and in contact with gratings of the Fresnel lens 108. In the example of FIG. 11D, gratings are provided on opposed sides of a Fresnel lens 108 which is interposed between two variable optical assemblies. Gratings on opposed sides of a Fresnel lens 108 may be disposed in contact with the two variable lens assemblies. In the example of FIG. 11E, a Fresnel lens is interposed between two variable optical assemblies and separated by an air gap 402 or other medium therebetween. In the examples of FIGS. 11F, 11G illustrating flash lens assemblies, a flash light 422 or light source is disposed spaced-apart in co-operation with various combinations of Fresnel lens and variable optical assembly for focussing a light beam emitted from the flash light 422. The flash light 422 may have reflectors 450 for redirecting the light beam. In the examples described above, the Fresnel lens 108 may have positive or negative Fresnel patterns, or a combination of both. FIG. 11H is a variation of FIG. 11A, but with the Fresnel lens disposed on a different side of the variable optical assembly. FIG. 11I is a variation of FIG. 11F, but with the Fresnel lens disposed on a different side of the variable optical assembly. In FIG. 11J, Fresnel gratings are formed on an interface between adjacent layers, e.g., an elastomeric material 202a and a flowable material 204a. One or more actuators 300 may be coupled to the variable optical assembly and/or the Fresnel lens 108 to control the deformation of the respective lens system coupled thereto to focus or defocus an incident light beam. Other arrangements employing a Fresnel lens 108 in cooperation with a variable lens assembly are possible. The Fresnel lens 108 can either be a variable Fresnel lens or a fixed Fresnel lens depending on application. The flash light may be a camera flash. The variable Fresnel lens may be deformed to achieve variable focus/performance Fresnel lens.

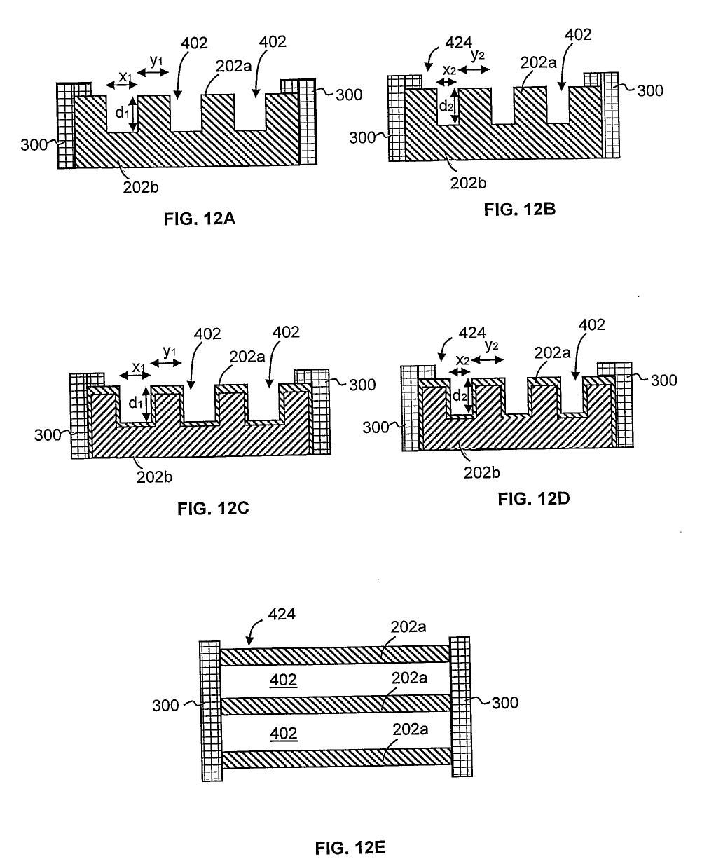

Reference is made to FIGS. 12A-12D illustrating cross-sectional views of a variable optical system having variable gratings. A variable optical system may employ a variable optical (grating) assembly including a single elastomeric material (FIGS. 12A-12B), multiple elastomeric materials (FIGS. 12C-12D) or, a combination of at least one elastomeric material and at least one flowable material. In the example of FIG. 12C, an actuator 300 may be coupled to one of the elastomeric materials 202a, 202b to control its deformation. In particular, the actuator 300 is coupled to the gratings 424 disposed at a periphery of the grating arrangement. During operation of the system and depending on requirements, the spacing or air gap between the gratings may be increased or decreased by activation of the actuator 300. Further, the grating constant of the variable optical system may be varied by the action of the actuator or application of an appropriate stimulus. FIG. 12C illustrates a variable optical system where the variable grating assembly comprises multiple elastomeric materials 202a, 202b. FIG. 12D illustrates the variable optical system of FIG. 12C in a deformed state. In particular, various parameters of the gratings 424 are changed, i.e., a spacing or air gap 402 between gratings 424 (x1≠x2), a height of the gratings 424 (d1≠d2), and a width of the gratings 424 (y1≠y2).

FIG. 12E illustrates a top cross-sectional view of a variable optical system having variable gratings, where an actuator 300 is coupled to each of the gratings 424 to provide direct and simultaneous control of a deformation of all the gratings 424.

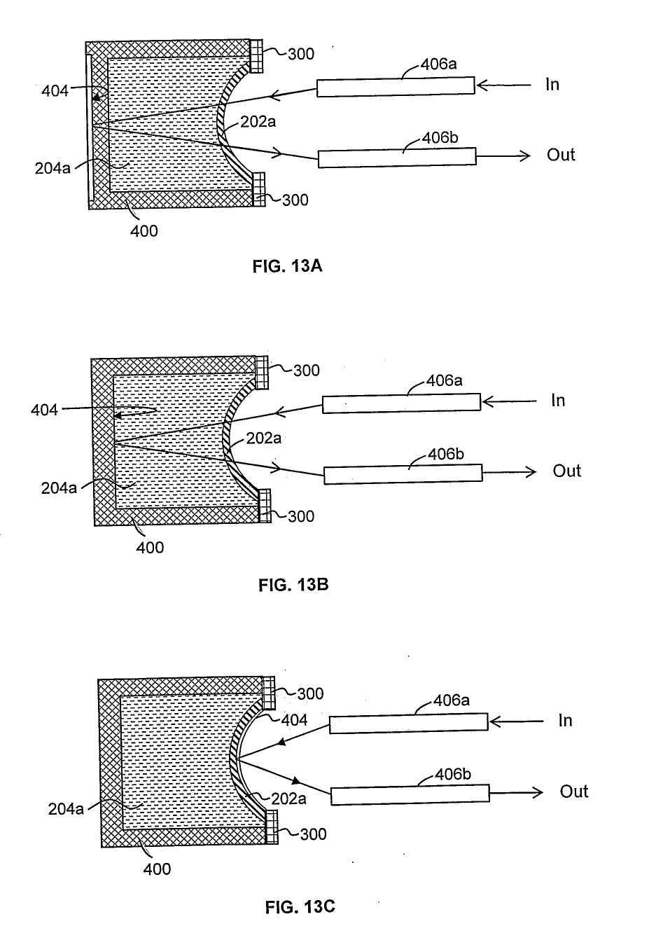

Reference is made to FIGS. 13A-130 illustrating cross-sectional views of tunable add-drop multiplexer/tunable optical cavity systems. The tunable add-drop multiplexer system may employ a variable optical (multiplexer) assembly including a single elastomeric material, multiple elastomeric materials, or a combination of at least one elastomeric material and at least one flowable material. In FIGS. 13A-13C, the multiplexer assembly includes an outer elastomeric material 202a and a flowable material 204a. A reflective coating or surface 404 may be disposed on the outermost surface or a surface remote from an outermost layer, e.g. on a surface of the housing 400 remote from the flowable material 204a (FIG. 13A), and on a surface of the housing adjacent to the flowable material (FIG. 13B). In both cases, an optical beam emitted from an input fiber optic cable 406a may enter the variable multiplexer assembly and be reflected upon incidence on the reflective coating 404. The reflected optical beam may then be received by an output fiber optic cable 406b. To this purpose, an actuator 300 may be coupled to the elastomeric material 202a to vary the thickness and/or shape of the outermost layer (optical cavity) to vary the tunability of the system. A housing 400 may be provided to retain the flowable material 204a. One or more fiber optic cables can be in contact with the inner or outermost layer(s). In FIG. 13C, the reflective coating 404 is disposed on an outer surface of the elastomeric material 202a and therefore an incident optical beam is reflected by the reflective coating 404 without entering the elastomeric 202a and flowable materials 204a.

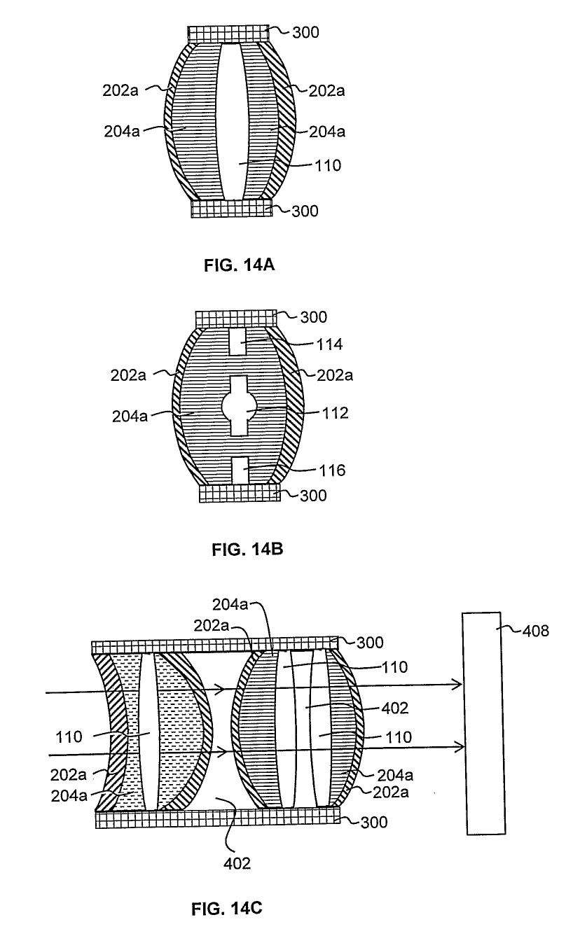

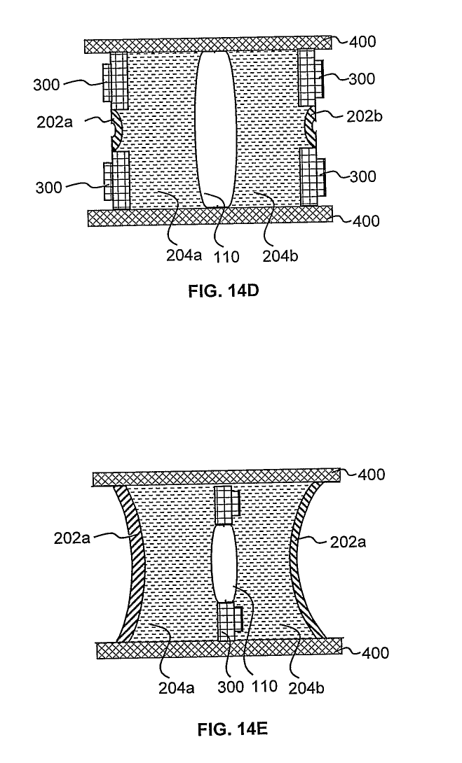

Reference is made to FIGS. 14A-14E illustrating a cross-sectional view of variable optical system employing combinations of variable optical assemblies and, fixed or dynamically shape-changeable lenses (soft lens) 110 for imaging applications, e.g. photography. In FIG. 14A, a fixed or a dynamically shape-changeable lens 110 is interposed between two variable lens systems. One or more actuators 300 may be coupled to selected layers to control the deformation of the selected layers coupled thereto. By deforming one or more of the layers, the variable optical system may provide zoom and focus functions. While the example in FIG. 14A, as a whole, provides a convex lens, it is to be understood other shapes, e.g. concave, convex-concave, concave-concave, spherical and non-spherical, may be provided according to embodiments of the invention.

In the example of FIG. 14B, a center lens 112, two side lenses 114, 116 may be provided and at least partially surrounded by the flowable material 204a. Elastomeric materials 202a may be provided on both sides of the flowable material 204a. The center lens 112, two side lenses 114, 116 may be a fixed or a dynamically shape-changeable lens as required. One or more actuators 300 may be coupled to selected layers to control the deformation of the selected layers coupled thereto. By deforming one or more of the layers, the variable optical system may provide zoom and focus functions. It is to be understood other shapes, e.g. concave, convex-concave, concave-concave, spherical and non-spherical, may be provided according to embodiments of the invention. The example of FIG. 14B may be incorporated to multi-layered lens configurations.

In the example of FIG. 14C, a first lens combination is formed by employing a fixed or dynamically shape-changeable lens 110 interposed between two variable lens assemblies. This first lens combination is separated from a second lens combination by an air gap 402 or other medium. The second combination is formed of a fixed or dynamically shape-changeable lens 110 juxtaposed with one variable lens assembly and is separated from a third combination by an air gap 402 or other medium. Depending on requirements, multiple actuators 300 may be coupled to selected materials of the variable lens system to control deformation of the materials coupled thereto. An imaging plane or sensor 408 may be appropriately disposed in cooperation with the combinations of lens systems to receive a light beam passing through the assemblies to form an image on the plane or sensor 408.

In the example of FIG. 14D, a solid or fixed lens or semi-fixed lens or dynamically shape-changeable lens 110 is interposed between layers of flowable materials 204a, 204b. Additionally, an elastomeric material 202a, 202b is provided on each side of the flowable materials 204a, 204b. Each elastomeric material 202a, 202b is coupled to an actuator 300 for controlling the deformation of the optical system as required. A deformation on the actuator will induce a deformation in the flowable materials 204a, 204b, elastomeric materials 202a, 202b and the lens 110 interposed therebetween. Alternatively, a deformation in the elastomeric material 202a, 202b may induce a deformation in at least one of the flowable materials 204a, 204b A housing 400 is also provided to retain the various materials described above. The elastomeric materials 202a, 202b used in both sides may be the same or different materials.

In the example of FIG. 14E, a solid or fixed lens or semi-fixed lens or dynamically shape-changeable lens 110 is interposed between layers of flowable materials 204a, 204b and is coupled to an actuator 300 for controlling its deformation as required. Additionally, an elastomeric material 202a is provided on each side of the flowable materials 204a, 204b. A deformation of the lens 110 will induce a deformation in the flowable materials 204a, 204b and elastomeric material 202a. A housing 400 is also provided to retain the various materials described above.

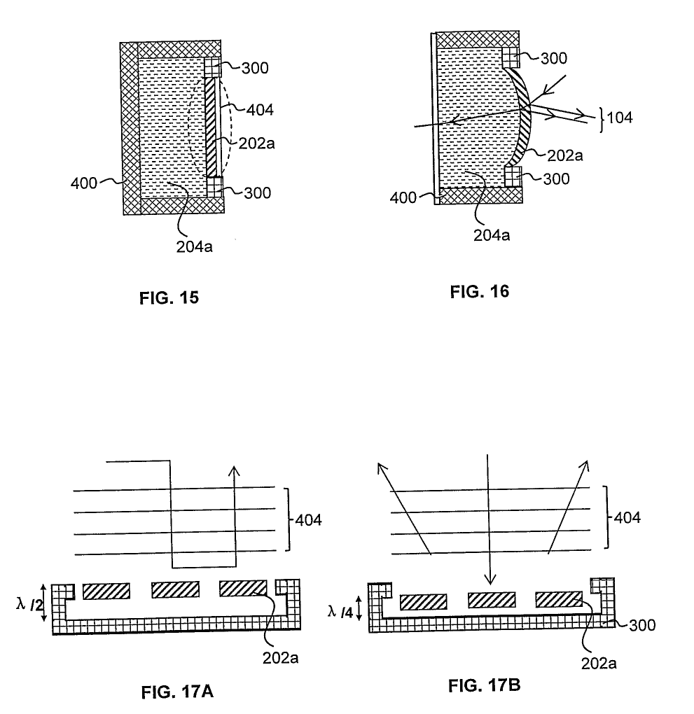

Reference is made to FIG. 15 illustrating a cross-sectional view of a shape-changing mirror. A shape-changing mirror may employ a variable optical (mirror) assembly including a combination of at least one elastomeric material, at least one flowable material and a reflective surface coating. In the example of FIG. 15, the mirror assembly comprises a flowable material 204a and an outermost (or inner) elastomeric material 202a having an outer optical surface which is coated with a reflective material 404. The elastomeric material 202a may be coupled to an actuator 300 suitably disposed to vary the thickness and/or shape of the flowable material 204a and the elastomeric material 202a. Possible deformation of the elastomeric material 202a together with its reflective coating 404 is indicated by dash lines in FIG. 15. A tilt or a shape of the reflective material may be varied by an actuator or an application of a stimulus.

A variable ratio beamsplitter may be obtained from the example of FIG. 15 by providing a reflective coating 404 which is semi-transparent or semi-silvered. When the elastomeric material 202a having the semi-transparent reflective coating expands, the semi-transparent coating reflects less light thereby increasing light transmission. When the elastomeric layer 202a having the semi-transparent reflective coating contracts, the semi-transparent coating reflects more light thereby decreasing light transmission. In this way, a variable ratio beam splitter effect may be obtained.

Reference is made to FIG. 16 illustrating a cross-sectional view of a variable non-reflective system with tunable non-reflective properties. A variable optical (non-reflective) system with tunable non-reflective properties may employ a variable non-reflective assembly comprising a single elastomeric material, or a combination of at least one elastomeric material and at least one flowable material. In the example of FIG. 16, the lens assembly comprises an outer elastomeric material 202a and a flowable material 204a. An actuator 300 may be coupled to the elastomeric layer 202a to vary its thickness and/or shape by means of deformation of the actuator. During operation of the variable optical system and depending on requirements, the elastomeric material 202a may be deformed to vary an optical path difference of a reflected optical beam 104 entering the elastomeric material 202a. At predetermined thickness and wavelength, an optical beam incident on the outer elastomeric material 202a produces reflected optical beams 104 which destructively interfere such that no reflection is obtained at the elastomeric material 202a. A thickness of the layers may be varied by the actuator or an application of a stimulus.

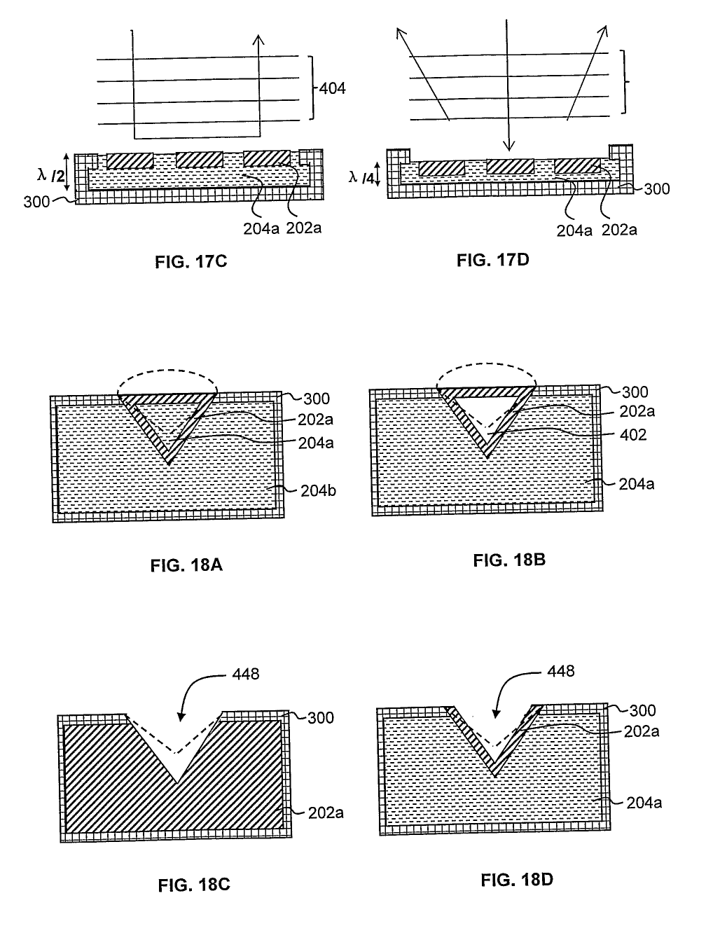

Reference is made to FIGS. 17A-17D illustrating cross-sectional views of a deformable grating light modulator (DGM). A deformable grating light modulator (DGM) may employ a DGM assembly comprising a single elastomeric material (FIGS. 17A-17B) or, a combination of at least one elastomeric material and at least one flowable material (FIGS. 17C-17D). In the example of FIGS. 17A-17B, the DGM assembly comprises an elastomeric material 202a coupled to an actuator 300 for controlling a deformation of the elastomeric material 202a. During operation of the deformable grating light modulator (DGM) and depending on requirements, the gratings may be moved relative to (away or towards) a surrounding reflective surface 404 to achieve diffraction or reflection effects. FIG. 17A illustrates a deformable grating light modulator having the grating up (at a distance of λ/2 where λ is the wavelength of the optical beam) to obtain full reflection effect. FIG. 17B illustrates a deformable grating light modulator having the grating down (λ/4) to achieve a diffraction effect.

In the example of FIGS. 17C-17D, the DGM assembly comprises an elastomeric material 202a and a flowable material 204a coupled to an actuator 300 for controlling a deformation of the materials. During operation of the deformable grating light modulator and depending on requirements, the gratings may be moved away or towards surrounding reflective surface to achieve diffraction or reflection effects. FIG. 17C illustrates a deformable grating light modulator having the grating up to obtain full reflection effect. FIG. 17D illustrates a deformable grating light modulator having the grating down to achieve a diffraction effect. The DGM may operate as a reflective device and/or a defractive device to an incident light beam.

Reference is made to FIGS. 18A-18D illustrating cross-sectional views of a variable reflective prism. A variable reflective prism may be formed of an optical (prism) assembly including one elastomeric material or a combination of at least one elastomeric material and at least one flowable material. In the example of FIG. 18A, the variable prism assembly comprises an outer elastomeric material 202a encapsulating a first flowable material 204a to form a prism structure. It should be noted that two or more elastomeric materials may be used to encapsulate the first flowable material and may be deformable independent of/dependent on each other. Additionally, a second flowable material 204b may be provided surrounding portions of the prism structure. Same or different materials may be selected for the first and the second flowable materials 204a, 204b. An actuator 300 may be coupled to the elastomeric material 202a to vary the thickness, shape and/or position of the prism. During operation and depending on requirements, the size, shape and/or position of the prism structure is changed to vary the amount of light reflected. FIG. 18A illustrates a variable reflective prism in a “pixel ON” position where an optical beam can be fully reflected. In a “pixel OFF” position where there is no reflection, a position of the outer elastomeric material 202a is indicated by dashed lines.

In the example of FIG. 18B, the variable reflective prism assembly comprises a prism structure formed of an elastomeric material 202a enclosing an air pocket 402 therein. A flowable material 204a is provided partially surrounding the prism structure. Dashed lines indicate a possible deformation of the prism structure.

In the example of FIG. 18C, the variable reflective prism assembly is formed of a single elastomeric material 202a in which an opening 448 is provided therein. The opening 448 is formed of angled surfaces. Dashed lines indicate a possible deformation of the elastomeric material 202a.

In the example of FIG. 18D, the variable reflective prism assembly is formed of a flowable material 204a and a single elastomeric material 202a in which an opening 448 is provided therein. The opening 448 is formed of intersecting angled surfaces. Dashed lines indicate a possible deformation of the elastomeric material 202a.

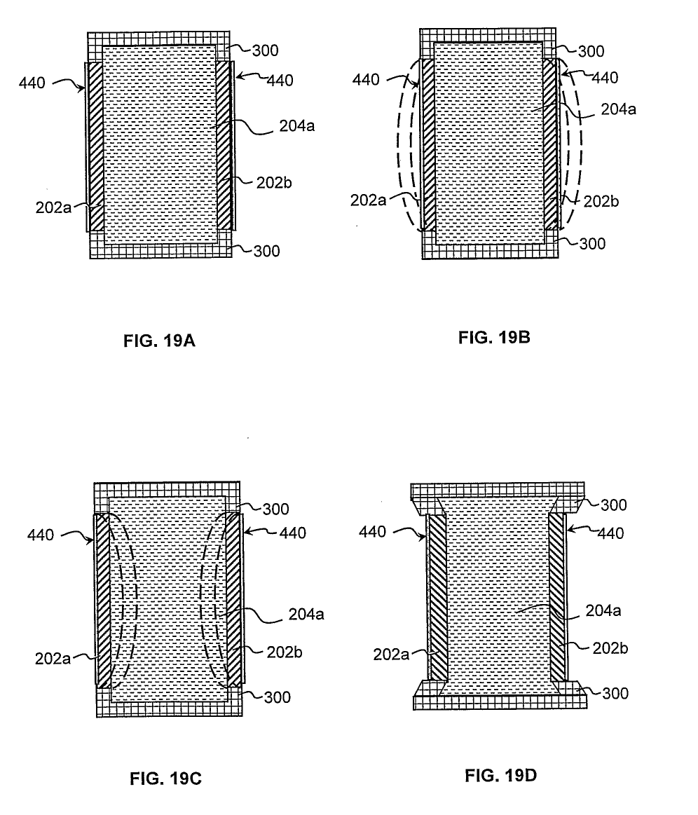

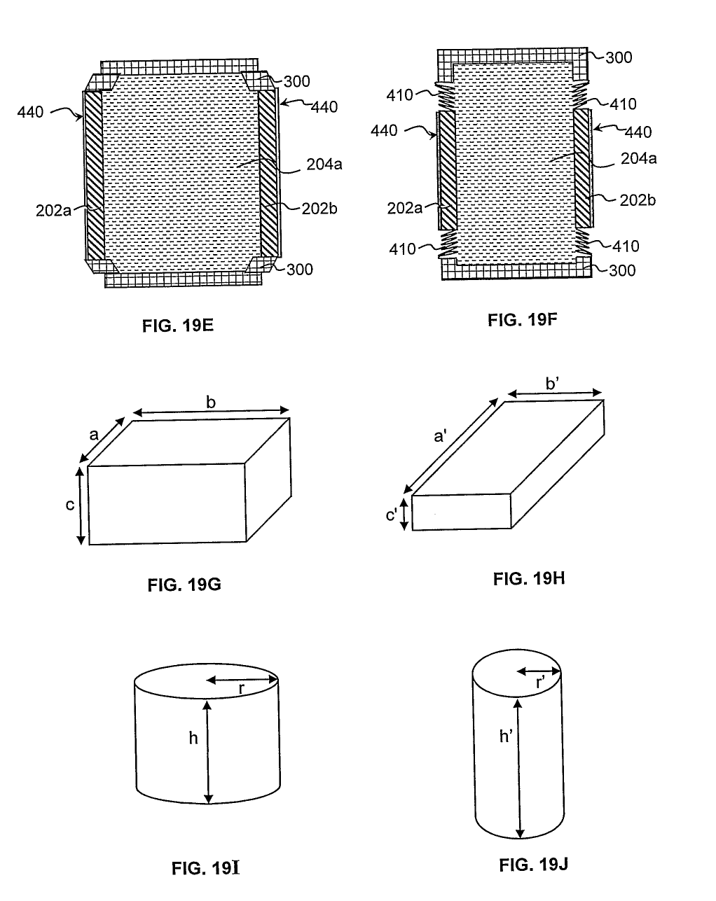

Reference is made to FIGS. 19A-19F illustrating cross-sectional views of variable Fabry-Perot interferometers or etalons. A variable Fabry-Perot interferometer or etalon may be formed of an optical assembly including a single elastomeric material or at least one flowable material 204a interposed between two elastomeric materials 202a, 202b. The elastomeric materials 202a, 202b are disposed in parallel to each other at a predetermined distance and may have semi-silvered coatings 440 provided on a surface of the elastomeric materials 202a, 202b. While FIGS. 19A-19F illustrate the semi-silvered coatings 440 provided on an outer surface of the elastomeric materials 202a, 202b, it is to be understood that the coatings 440 may be provided on an inner surface of the elastomeric materials 202a, 202b. One or more actuators 300 may be coupled to the elastomeric materials 202a, 202b to vary the thickness, shape, or position of the elastomeric materials 202a, 202b, or a combination thereof. When a light beam enters through one of the elastomeric materials 202a, 202b, the light beam is internally reflected between the two elastomeric materials 202a, 202b. Upon activation of the actuators 300, the elastomeric materials 202a, 202b may be appropriately deform to adjust the spacing therebetween such that the spacing is an integer multiple of the wavelength of the incident light beam. This way, an incident optical beam may be transmitted through the interferometer or etalon. By varying the distance between the elastomeric materials 202a, 202b, or a spacing between the semi-silvered coatings, the resonant pass-band may be tuned. FIG. 19B illustrates the variable Fabry-Perot interferometer of FIG. 19A having an increased spacing between the elastomeric materials 202a, 202b forming a biconvex structure. FIG. 19C illustrates the variable Fabry-Perot interferometer of FIG. 19A having a decreased spacing between the elastomeric materials 202a, 202b forming a biconcave structure. FIG. 19D illustrates the variable Fabry-Perot interferometer of FIG. 19A having a decreased spacing between the elastomeric materials 202a, 202b disposed in a parallel arrangement. FIG. 19E illustrates the variable Fabry-Perot interferometer of FIG. 19A having an increased spacing between the elastomeric materials 202a, 202b disposed in a parallel arrangement. FIG. 19F illustrates a variable Fabry-Perot interferometer having corrugated supports 410 coupling outer elastomeric or inelastic materials to the actuator and/or housing to facilitate parallel movements of the materials. Similarly, the elastomeric or inelastic materials may be semi-silvered and interpose at least a flowable material 204a therebetween. In other embodiments, a variable Fabry-Perot interferometer or etalon may be formed of an optical assembly including a single or multiple elastomeric materials.

FIGS. 19G-19J illustrate possible deformation of the variable Fabry-Perot interferometers illustrated in FIGS. 19A-19F. More particularly, the actuator 300 deforms the optical assembly of the interferometers to maintain a constant shape and volume. In this connection, dimensions (a, b, c, a′, b′, c′) of the optical assembly are appropriately sized to achieve the constant shape and volume. FIGS. 19G-19H illustrate possible deformation in one embodiment while FIGS. 19I-19J illustrate possible deformation in another embodiment. In order to keep the shapes and volumes constant when an incompressible material is used, the condition a×b×c=a′×b′×c′ should be satisfied for embodiments of FIGS. 19G and 19H, and for the embodiments of FIGS. 19I and 19J, the condition π r2 h=π(r′)2 h′ should be satisfied. When a compressible material is used, the above conditions may or may not be required.

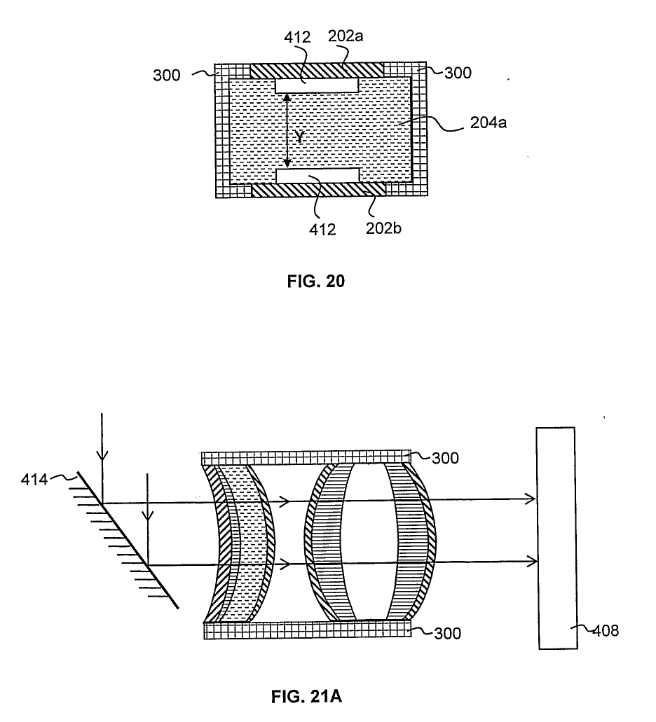

Reference is made to FIG. 20 illustrating a cross-sectional view of a tunable infrared (IR) Fabry-Perot interferometer. A tunable IR Fabry-Perot interferometer may be formed of an optical assembly including a flowable material 204a interposed between two elastomeric materials 202a, 202b, and multiple dielectric mirrors 412 disposed in juxtaposition with the elastomeric materials 202a, 202b within the flowable material 204a. One or more actuators 300 may be coupled to the elastomeric materials 202a, 202b to vary the thickness, shape, or position of the elastomeric materials 202a, 202b, or a combination thereof. More particularly, a deformation of the elastomeric and/or flowable materials 202a, 202b varies a spacing (Y) between the dielectric mirrors 412 to tune the infrared Fabry-Perot interferometer. In other embodiments, a tunable IR Fabry-Perot interferometer may be formed of an optical assembly including a single or multiple elastomeric materials.

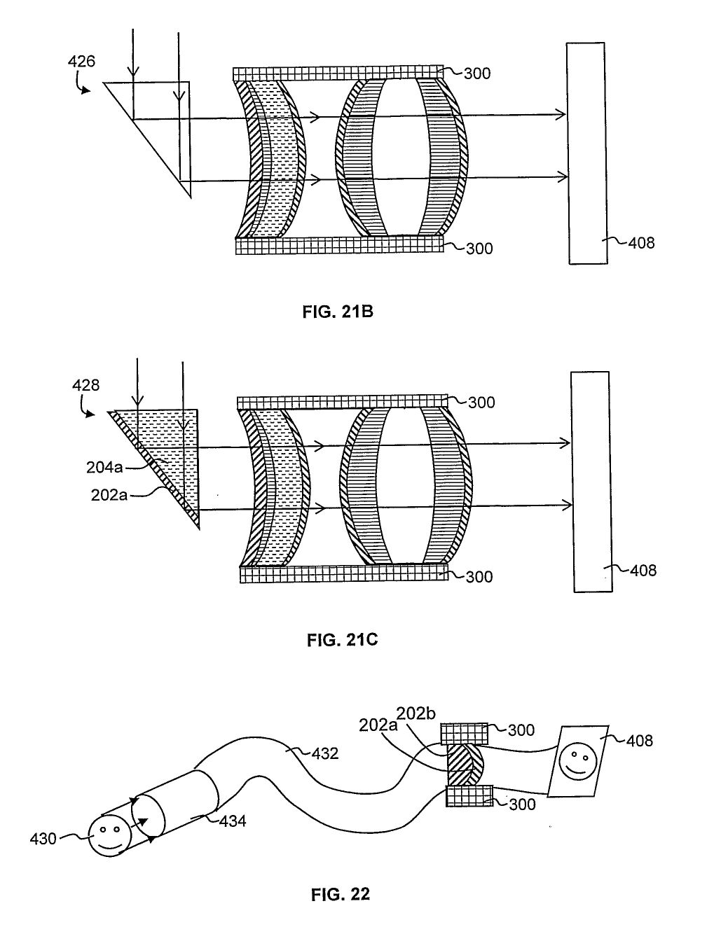

Combinations of some of the above applications may be envisaged for various optical system applications in cooperation with reflective devices, e.g. mirrors, fixed prisms, variable prisms for diverting optical beams to a variable optical system. An imaging plane or sensor 408 may be disposed in cooperation to receive an optical beam from the variable optical system. For example, FIG. 21A illustrates a mirror 414 disposed in cooperation with the variable optical system of FIG. 14C in certain optical applications, e.g. imaging and photography. The mirror 414 may be used to bend or change direction of an incident optical beam so that the optical beam is directed to pass through one or more combinations of optical assemblies to ultimately form an image on an imaging plane or sensor 408. Alternative to using a mirror 414, a prism or a prism having a reflective surface may be used with suitable modifications. FIG. 21B illustrates a fixed prism 426 disposed in cooperation with the variable optical system of FIG. 14C. FIG. 21C illustrates a variable prism 428 disposed in cooperation with the variable optical system of FIG. 14C.

FIG. 22 illustrates multiple optical systems incorporated in a light guide 432 to capture an image of an object 430 onto an imaging plane 408. A first optical system, provided as a fixed or variable lens assembly 434 may be disposed proximate to an object 430. A second optical system, provided as a fixed lens assembly or as variable lens assembly comprising multiple elastomeric materials, or at least an elastomeric material 202a and a flowable material 204a, may be disposed proximate to an imaging plane 408 or device, in order to focus a light beam or an image transmitted through the light guide 432 onto the imaging plane 408.

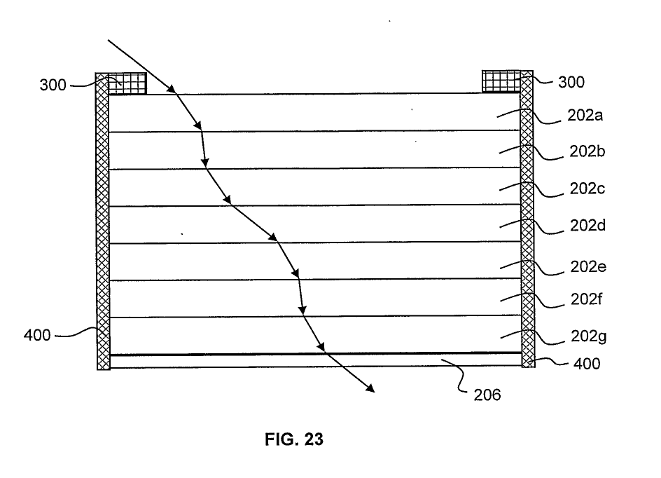

FIG. 23 illustrates a graded layered lens system. The graded lens system may be formed of several juxtaposed layers, e.g. elastomeric materials 202a-202g, flowable materials or a combination thereof. The layers may have different optical properties, e.g. refractive indices, so that an optical beam may be transmitted through the layered lens travel in a non-straight or curved path. A housing 400 may be provided to retain the multiple layers and a transparent substrate 206 may be provided to allow output transmission of the optical beam. An actuator 300, as described in the earlier paragraphs, may be provided to actuate a deformation in one or more of the layers in the graded lens system.

In the above embodiments as well as other embodiments, the interface between adjacent layers in the optical system may have a sharp (well-defined) boundary or a diffused (less sharply-defined) boundary.

Embodiments of the invention are particularly advantageous in enhancing the performance of various optical applications, including but not limited to, multi-function lenses, singlets, doublets, achromats, apochromats, super-achromats, triplet objectives, eyepieces, magnifiers, heads-up displays, afocal systems, beam expanders, cooke triplets, inverse telephoto, retrofocus, wide angle lenses, telephotos, double-meniscus lenses, panoramic lenses, compound lenses, Petzval lenses, microscopic objectives, double Gauss lenses, relay lenses, endoscopes, periscopes, riflescopes, mirror telescopes, catadioptric systems, unobscured telescopes, scanning F-theta lenses, laser-focusing lenses, aerial photography lenses, zoom lenses, infrared lenses, ultraviolet lenses, projection lenses, prisms, wedges, gradient index lenses, and diffractive optic lenses.

It is to be understood that the multi-layered structure of various optical systems described herein may be manufactured by methods including, but not limited to, dispensing, molding (e.g. injection molding), casting, placement, curing, melting, or any combination of the above, or other methods.

Other embodiments will be apparent to those skilled in the art from consideration of the specification and practice of the present invention. Furthermore, certain terminology has been used for the purposes of descriptive clarity, and not to limit the invention. The embodiments and features described above should be considered exemplary, with the invention being defined by the appended claims.

1-271. (canceled)

272. A variable optical system comprising:
a variable optical assembly including a plurality of deformable layers selectively operable to vary at least one of: an optical property of at least one of the layers, a physical property of at least one of the layers, and an optical performance of the assembly, while maintaining a constant mass in the layers, wherein each layer has an optical function, wherein the layers are juxtaposed to each other, and wherein one of the layers is selectively operable to deform independent of an adjacent'one of the layers.

273. The variable optical system of claim 272, wherein a volume is maintained in the layers, wherein the volume inconstant or variable volume, wherein a lens is interposed between the layers, and the lens is selected from the group consisting of a solid lens, a fixed lens, a semi-fixed lens and a dynamically shape-changeable lens,
wherein an elastomeric material coupled to each of the layers; and
wherein an actuator coupled to the elastomeric material for controlling a deformation thereof.

274. The variable optical system of claim 272, wherein one of the layers is selectively operable to receive a stimulus, being at least one of heat, light, electromagnetic radiation, stress, pressure, magnetic field, electric field, humidity, target analyte, gas, and biological organism.

275. The variable optical system of claim 274, wherein the stimulus is to vary at least one of an optical property, an optical performance, a physical shape and a physical property,
wherein the optical property being at least one of refractive index, light transmission coefficient, absorption coefficient; dispersion power, and polarization, and
wherein the optical performance of the optical assembly being at least one of focal length, optical power, reflective performance, refractive performance, polarization, spot size, resolution, modulation transfer function (MTF), distortion, and diffractive performance and wherein the layers include at least a flowable material and an elastomeric material.

276. The variable optical system of claim 275, wherein the flowable material is provided in a solid state and is operable to possess a fluidic property by applying a stimulus.

277. The variable optical system of claim 276, wherein the stimulus is at least one of heat, light, electromagnetic radiation, stress, pressure, magnetic field, electric field, humidity, target analyte, gas, and biological organism.

278. The variable optical system of claim 275, wherein the flowable material is a liquid crystal.

279. The variable optical system of claim 275, wherein an air pocket is provided in the flowable material to increase an optical power of the optical assembly.

280. The variable optical system of claim 272, wherein the layers include a plurality of solid, flowable and elastomeric materials disposed in an alternating arrangement.

281. The variable optical system of claim 272, further comprising a first actuator coupled to at least one of the layers for controlling a deformation thereof,
wherein the first actuator includes a first actuating material mounted on a first substrate, the first actuating material and the first substrate having an opening therethrough for disposing at least one of the layers therein, the first substrate being coupled to the one of the layers, and
wherein the first actuating material is one of a piezoelectric material, a shape memory alloy, a bi-metal material and a thermal material.

282. The variable optical system of claim 272, further comprising a first actuator coupled to the optical assembly for controlling a movement of the optical assembly,
wherein the movement of the optical assembly is to induce a deformation in a layer juxtaposed to the optical assembly, wherein the movement of the optical assembly is to focus an image onto an imaging plane.

283. The variable optical system of claim 282, wherein the first actuator is an electrowetting device which includes a conductive flowable material coupled to a dielectric material which is coupled to the one of the layers.

284. The variable optical system of claim 272, further comprising a controller for controlling a movement of the variable optical assembly along an optical axis.

285. The variable optical system of claim 284, wherein the controller is a voice coil motor.

286. The variable optical system of claim 272, wherein the layers have same refractive indices, dispersion coefficients, transmission coefficient, stretchabilities, or a combination thereof.

287. The variable optical system of claim 272, wherein the layers have different refractive indices, dispersion coefficients, transmission coefficient, stretchabilities, or a combination thereof.

288. The variable optical system of claim 272, wherein the variable optical assembly is employed in one of a waveguide, an interferometer, an add-drop multiplexer, a prism, a reflector system, a optical filter, a variable Fresnel lens system, an optical system having variable gratings, a tunable add-drop multiplexer, a shape-changing mirror, a variable/multi ratio beamsplitter, a variable zoom/focus lens system, a variable lens system with tunable non-reflective properties, a deformable grating light modulator (DGM), a reflective prism, a Fabry-Perot interferometer, camera, compact camera module and a tunable infrared (IR) Fabry-Perot interferometer.

289. A reflector system comprising:
a variable optical assembly including a plurality of deformable layers selectively operable to vary at least one of: an optical property of at least one of the layers/reflector system, a physical property of at least one of the layers/reflector system, and an optical performance of the assembly, while maintaining a constant mass in each layer, wherein each layer has an optical function, wherein the layers are juxtaposed to each other, and wherein one of the layers is selectively operable to deform independent of an adjacent one of the layers;
wherein at least one of the layers is a Fresnel lens; wherein the Fresnel lens is deformable to achieve a variable focus/performance Fresnel lens, and
wherein a reflective material coated on at least one of the layers.

290. The variable optical system of claim 289, further comprising a flash light disposed in cooperation with the variable optical system

291. The variable optical system of claim 290, wherein the flash light is a camera flash.

292. A method of operating a variable optical system having a plurality of deformable layers, the method comprising:
varying at least one of an optical property, a physical property, and an optical performance of at least one of the layers, while maintaining a constant mass in each layer, wherein each layer has an optical function, by applying a stimulus or an actuation movement to the at least one of the layers, wherein each of the layers has an optical function, wherein the layers are juxtaposed to each other, and wherein one of the layers is selectively operable to deform independent of an adjacent one of the layers.

293. The method of claim 292, wherein the stimulus being at least one of heat, light, electromagnetic radiation, stress, pressure, magnetic field, electric field, humidity, target analyte, gas, and biological organism.

294. A variable optical system comprising:
a variable optical assembly including a plurality of deformable and/or non-deformable layers selectively operable to vary at least one of: an optical property of at least one of the layers, a physical property of at least one of the layers, and an optical performance of the assembly, while maintaining a constant mass in the layers, wherein each layer has an optical function, wherein the layers are juxtaposed with each other and have different optical properties for transmitting a light beam through the layers in a non-straight path.

295. The variable optical system of claim 294, wherein a constant volume is to be maintained in the layers.

296. The variable optical system of claim 294, wherein a variable volume is to be maintained in the layers.

297. The variable optical system of claim 294, wherein one of the layers is selectively operable to deform independent of a remaining of the layers.
